(19) United States
(12) Patent Application Publication
(10) Pub. No.: US 2017/0116658 A1
(43) Pub. Date: Apr. 27, 2017

(54) Objective Function Based Engine To Create Smart Product Groupings

(71) Applicant: GOOGLE INC., Mountain View, CA (US)

(72) Inventors: Akanksha Baid, Fremont, CA (US); Shravan Rayanchu, Fremont, CA (US)

(21) Appl. No.: 14/920,864

(22) Filed: Oct. 22, 2015

(51) Int. Cl. G06Q 30/06; G06F 17/30

(52) U.S. Cl. CPC G06Q 30/0625; G06F 17/30345; G06F 17/30598; G06F 17/30867

(57) ABSTRACT

A product categorization system receives a merchant system product feed, product sales data, and product search data from a merchant system and a search system. The product categorization system generates product category tags for each product listing of the merchant system product feed based on merchant system product feed data. The product categorization system assigns product listings to product categories based on the tags associated with each product listing and organizes the product listings within the product categories based on sales data and search data to create product category pages for a merchant system website. The product categorization system generates website data comprising the one or more category pages comprising the organized product listings and transmits the website data to the merchant system for display on the merchant system website. The website displays the product category pages comprising organized product listings as generated by the product categorization system.

### TECHNICAL FIELD

The present disclosure relates to improving the organization of product listings on merchant websites or on merchant system mobile device applications by organizing product listings into categories based on merchant system product information and organizing product listings within categories based on product sales and product search information.

### BACKGROUND

Generally, to update product listings displayed on merchant system sales websites or merchant system mobile applications, website or mobile application administrators associated with the merchant system must manually add, edit, delete, reorganize, insert, or perform other appropriate actions with respect to product listings on product category pages of merchant system sales websites or product category pages on mobile applications. A website administrator or mobile application administrator creates product category pages for a merchant system website or merchant system mobile application and then may use drag and drop user interface tools to manually edit the product category pages on the website or mobile application.

Current applications for organizing product listings to display on merchant system sales websites and/or mobile applications do not provide for generating product category pages for product listings based on merchant system product data and organizing product listings within product category pages based on product sales data and product search data. Current applications for organizing a display of product listings on merchant system sales websites and/or mobile applications also do not provide for dynamically re-generating product category pages for product listings and re-organizing product listings within product category pages in response to changes in merchant system product data, product sales data, and/or product search data.

### SUMMARY

Techniques herein provide computer-implemented methods to dynamically generate and update product category pages for a merchant sales website based on a merchant product feed, sales data, and search data. In an example embodiment, a product categorization system receives a merchant system product feed, product sales data, and/or product search data from a merchant system and/or a search system. The product categorization system may generate product category tags for each product listing of the merchant system product feed based on merchant system product feed data. The product categorization system assigns product listings to product categories based on the tags associated with each product listing and organizes the product listings within the product categories based on sales data and search data to create product category pages for a merchant system website. The product categorization system may then generate website data comprising the one or more category pages comprising the organized product listings and transmit the website data to the merchant system for display on the merchant system website. The product categorization system may receive updated merchant product feed data, updated search data, and/or updated sales data from the merchant system and/or the search system. The product categorization system may repeat the process for generating product category pages and organizing the product listings within category pages based on the updated data. The updated merchant system website may include additional product category pages not present in a previous version of the website or mobile application display, may include changes to existing product category pages that were present in the previous version of the website, or may delete product category pages that previously existed in the previous version of the website.

In certain other example aspects described herein, systems and computer program products to dynamically generate and update product category pages for a merchant sales website based on a merchant product feed, sales data, and search data are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to dynamically generate and update product category pages for a merchant sales website based on a merchant product feed, sales data, and search data, in accordance with certain example embodiments.

FIG. 2 is a block flow diagram depicting a method to dynamically generate and update product category pages for a merchant sales website based on a merchant product feed, sales data, and search data, in accordance with certain example embodiments.

FIG. 3 is a block flow diagram depicting a method to receive, by a product categorization system, a merchant system product feed, product sales data, and product search data, in accordance with certain example embodiments.

FIG. 4 is a block flow diagram depicting a method to generate, by a product categorization system, product category tags for each product listing based on merchant system product feed, in accordance with certain example embodiments.

FIG. 5 is a block flow diagram depicting a method to organize, by a product categorization system, product listings into categories, in accordance with certain example embodiments.

FIG. 6 is a block flow diagram depicting a method to organize, by a merchant product categorization system, product listings within categories, in accordance with certain example embodiments.

FIG. 7 is a block flow diagram depicting a method to generate, by a product categorization system, product category pages and to transmit product category pages to a merchant website for display, in accordance with certain example embodiments.

FIG. 8 is a block flow diagram depicting a method to interact, by a user, with a merchant system website to select a product listing on a product category page, in accordance with certain example embodiments.

FIG. 9 is a block flow diagram depicting a method to purchase, by a user, a selected product listing on a category page from a merchant system via an online transaction, in accordance with certain example embodiments.

FIG. 10 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques for dynamically generating and updating product category pages for a merchant website or application based on a merchant product feed, sales data, and search data. An example merchant sales website may comprise a traditional website, a mobile website designed to be displayed in mobile user computing device web browsers, an application that displays pages of product information, or any other type of website, application, document, or other data accessible by a user computing device over a network. In certain example embodiments, instead of generating and/or updating a merchant sales website, the product categorization system generates and/or updates mobile computing device applications.

In an example embodiment, a product categorization system receives a merchant system product feed, product sales data, and/or product search data from a merchant system and/or a search system. The product categorization system may generate product category tags for each product listing of the merchant system product feed based on merchant system product feed data. For example, the tags may be generated based on title data, description data, breadcrumb data, and/or price data associated with each product listing in the merchant system product feed. Then, the product categorization system assigns product listings to product categories based on the tags associated with each product listing and organizes the product listings within the product categories based on sales data and search data to create product category pages for a merchant system website. The product categorization system may then generate website or application page display data comprising the one or more category pages with the organized product listings and transmit the display data to the merchant system for display on the merchant system website or via the merchant application. The product categorization system may receive updated merchant product feed data, updated search data, and/or updated sales data from the merchant system and/or the search system. The product categorization system may repeat the process for generating product category pages and organizing the product listings within category pages based on the updated data. The updated merchant system website may include additional product category pages not present in a previous version of the website, may include changes to existing product category pages that were present in the previous version of the website, or may delete product category pages that previously existed in the previous version of the website. The product categorization system transmits data to the merchant system over the network that enables a merchant system server to provide and support the merchant system website so that user computing devices may access the website via the network and display the website to users. This data may further comprise instructions to create individual product category pages and to display corresponding product listings on each product category page according to the updated merchant system website design and organization generated by the product categorization system. The data may further comprise other instructions to enable the server to provide a virtual shopping cart functionality on the website that enables a user to select product listings displayed on the website to add to the virtual shopping cart and initiate a transaction for those product listings.

More specifically, the product categorization system receives a product feed from the merchant system. For example, the product feed comprises title data, description data, price data, and other applicable data associated with each product listing of multiple product listings that the merchant system wants to offer for sale on the merchant system website. The product categorization system further receives product sales data associated with each of the product listings from the merchant system. The product sales data may comprise a conversion rate, a bounce rate describing comprising a percentage of users who leave the website after viewing a product listing, an add-to-cart rate, an average time spent on product category listing, bought-together data, and/or current stock data associated with each product listing. The product categorization system may also receive other types of sales data in addition to these specified types. The product categorization system receives product search data from a search system. For example, the product categorization system may determine one or more keywords associated with the product listing based on the title data or the description data and request the search data for each keyword from the search system. Example search data may comprise a search volume and/or a trending indicator associated with each keyword.

The product categorization system determines product category tags for each product listing based on one or more of the title data, description data, price data, and/or other data received in the merchant system product feed. The product categorization system determines an applicability of each product category tag to each corresponding product listing by comparing the product title and description data against each other. The product categorization system generates category pages comprising product listings with a high probability for respective product category tags. For example, a high probability comprises a probability higher than a predefined threshold probability, for example, 99.5% probability or any other appropriate threshold probability. The product categorization system may integrate product category pages into an existing merchant system website hierarchy if applicable.

The product categorization system organizes product listings within category pages based on sales data and search data associated with each product listing. For example, the product categorization system may organize product listings based on one or more of conversion data, average time spent on product listing, add-to-cart rate data, trending data, search volume data, bought-together data, bounce rate data, and/or current stock data. The product categorization system may also base an organization of the product listings within a particular product category page based on other appropriate sales data, search data, or even merchant feed data in addition to or instead of one or more of the sales data and search data types described herein. The product categorization system generates merchant system website data incorporating the generated, organized product category pages into the merchant system website. The product categorization system transmits the website data to the merchant system and the merchant system displays the website incorporating the product category pages generated by the product categorization system.

The product categorization system may update the merchant system website in response to receiving updated product feed data, sales data, and/or search data. The product categorization system, in response to receiving the new data, may edit one or more existing product category pages, rearrange the order of the product listings on one or more of the merchant category pages, delete one or more product listings from one or more product category pages, delete one or more product category pages, rearrange and/or reorganize a hierarchical organization of product category pages, and/or generate one or more new product category pages. In this example, the product categorization system may also add or delete items from existing product category pages based on additions, deletions, or edits that the merchant system made to an updated merchant system product feed. In an example embodiment, the product categorization system generates a code or other data representing the updated website or updated sections of the existing website and transmits the updated website data to the merchant system along with instructions instructing the merchant system how to incorporate the updated website data into the existing website. In an example embodiment, the merchant system overwrites the previous version of the website with the received website data. In another example, the merchant system may insert or overwrite updated website data into the existing website and delete, cut and paste, or otherwise update some or all of the previous website data to integrate updated portions of the website generated by the product categorization system into the existing website data representing the previous version of the website. In an example embodiment, the merchant system displays the updated website comprising any updates, additions, deletions, rearrangements, or other appropriate actions taken by the product categorization system with respect to product category pages, product category page organization within the website, and/or individual product listings in response to the new product feed data, sales data, and/or search data with respect to the previous version of the website. In other example embodiments, instead of updating a merchant system website, the product categorization system generates data comprising a hierarchical grouping of products in product category pages that the user can navigate via the network via a shopping application on the user computing device.

The user accesses the merchant system website via a user computing device, selects a product category page and further selects a product listing to add the selected product to a virtual shopping cart. In another example, the user may select a product listing and be directed to a web page that describes the selected product listing. For example the web page may comprise information about the selected product listing, such as title data, description data, price data, and one or more user interface objects that allow the user to access further information, add the product listing to the virtual shopping card, or perform another appropriate action with respect to the product listing on the web page devoted to the product listing. The user initiates a checkout process, and the merchant system processes a transaction based on financial account information and shipping information received from the user. The user may also select an option on the merchant system website to make a payment via a digital wallet account associated with a payment processing system.

By using and relying on the methods and systems described herein, the merchant system, the search system, and the product categorization system enable the merchant system to provide a website or application that is dynamically organized into category pages according to product feed data and comprising product listings organized according to sales data and search data. By using and relying on the methods and systems described herein, the merchant system, the search system, and the product categorization system enable the merchant system to provide a website or application that can be automatically updated with respect to the titles of product category pages, the organization of product category pages, and/or the organization of product listings within the category pages in response to changes in the merchant system product feed data, changes in merchant system sales data, and/or changes in search data provided by the search system. As such, the systems and methods described herein may reduce the inputs required by an operator of the merchant system to maintain an updated merchant system sales website.

### Example System Architecture

Turning now to the drawings, in which like numerals indicate like (but not necessarily identical) elements throughout the figures, example embodiments are described in detail.

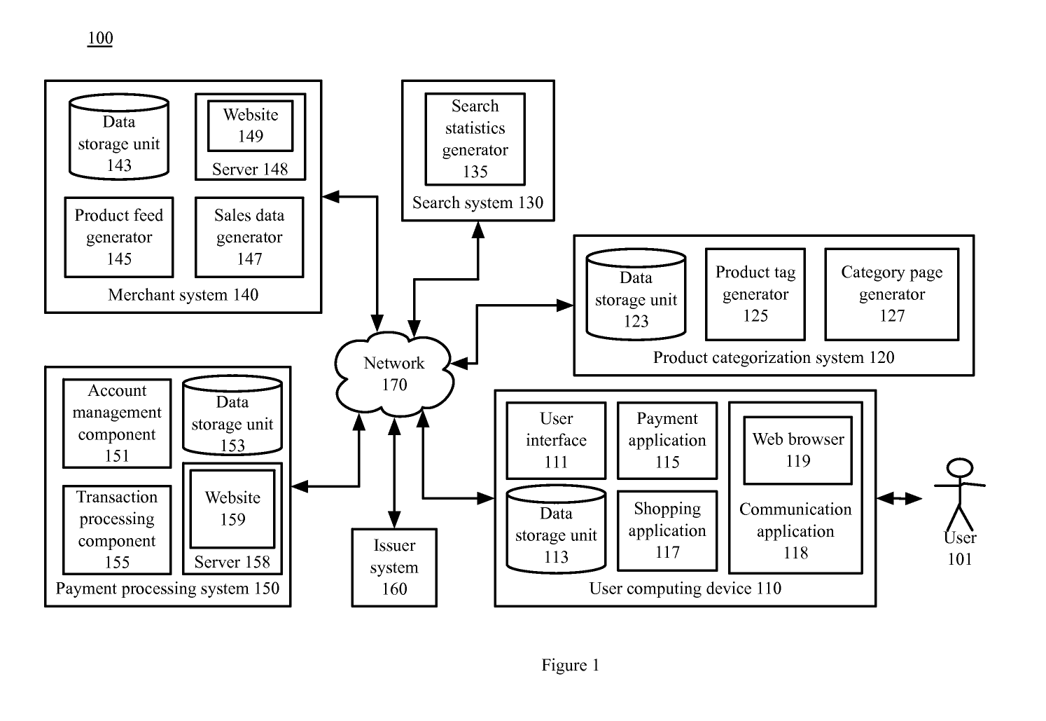

FIG. 1 is a block diagram depicting a system 100 to dynamically generate and update product category pages for a merchant sales website based on a merchant product feed, sales data, and search data, in accordance with certain example embodiments. As depicted in FIG. 1, the system 100 includes network computing devices 110, 120, 130, 140, 150, 160 that are configured to communicate with one another via one or more networks 170. In some embodiments, a user associated with a device must install an application and/or make a feature selection to obtain the benefits of the techniques described herein.

In example embodiments, the network 170 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 120, 130, 140, 150, and 160 includes a device having a communication module capable of transmitting and receiving data over the network 170. For example, each network computing device 110, 120, 130, 140, 150, and 160 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 120, 130, 140, 150, and 160 are operated by users 101, product categorization system 120 operators, search system 130 operators, merchant system 140 operators, payment processing system 150 operators, and issuer system 160, respectively.

An example user computing device 110 comprises a user interface 111, a data storage unit 113, a payment application 115, a shopping application 117, a communication application 118, and a web browser 119.

In an example embodiment, the user interface 111 enables the user 101 to interact with the payment application 115, the shopping application 117, and/or the web browser 119. For example, the user interface 111 may be a touch screen, a voice-based interface, or any other interface that allows the user 101 to provide input and receive output from an application or module on the user computing device 110.

In an example embodiment, the data storage unit 113 comprises a local or remote data storage structure accessible to the user computing device 110 suitable for storing information. In an example embodiment, the data storage unit 113 stores encrypted information, such as HTML5 local storage.

In an example embodiment, the payment application 115 is a program, function, routine, applet, or similar entity that exists on and performs its operations on the user computing device 110. In certain example embodiments, the user 101 must install the payment application 115 and/or make a feature selection on the user computing device 110 to obtain the benefits of the techniques described herein. In an example embodiment, the user 101 may access payment application 115 on the user computing device 110 via the user interface 115. In an example embodiment, the payment application 115 may be associated with the payment processing system 150. In another example embodiment, the payment application 115 may be associated with the merchant system 140.

In an example embodiment, the shopping application 117 is a program, function, routine, applet, or similar entity that exists on and performs its operations on the user computing device 110. In an example embodiment, the shopping application 117 may be associated with the merchant system 140. In certain example embodiments, the user 101 must install the shopping application 117 and/or make a feature selection on the user computing device 110 to obtain the benefits of the techniques described herein. In an example embodiment, the user 101 may access the shopping application 117 on the user computing device 110 via the user interface 111. In an example embodiment, the user computing device 110 accesses the merchant system website 149 via the shopping application 117, which communicates with the merchant system 140 via the network 170. In another example embodiment, the user computing device 110 accesses the merchant system server 148 via the shopping application 117 and receives data via the network 170 comprising multiple product category pages for display via the shopping application 117. In this example embodiment, the server 148 provides data content to display on the shopping application 117 and, instead of navigating a merchant website 149 via the web browser 119, the user 101 navigates data stored on the server 148 communicated via the network 170 for display on the shopping application 117 comprising a hierarchical interface having multiple category pages including organized product listings.

In certain example embodiments, one or more functions herein described as performed by the shopping application 117 may also be performed by a web browser 119 application, for example, a web browser 119 application associated with a merchant system website 149. In an example embodiment, the shopping application 117 may be associated with the payment processing system 150. In certain example embodiments, one or more functions herein described as performed by the shopping application 117 may also be performed by the user computing device 110 operating system. In certain example embodiments, one or more functions herein described as performed via the web browser 118 may also be performed via the shopping application 117.

In an example embodiment, the user 101 can use a communication application 118, such as a web browser 119 application or a stand-alone application, to view, download, upload, or otherwise access documents or web pages via a distributed network 170.

In an example embodiment, the web browser 119 can enable the user 101 to interact with web pages using the user computing device 110. In an example embodiment, the user 101 may access the user's 101 account maintained by the payment processing system 150 via the web browser 119. In another example embodiment, the user 101 may access the a merchant system website 149 via the web browser 119. In certain example embodiments described herein, one or more functions performed by the payment application 115 may also be performed by a web browser 119 application. In certain example embodiments, one or more functions performed by the shopping application 117 may be performed by a web browser 119 application or the user computing device 110 operating system. In certain example embodiments, one or more functions performed by the web browser 119 may be performed by the payment application 115 and/or the shopping application 117.

In an example embodiment, the communication application 118 can interact with web servers or other computing devices connected to the network 140, including the user computing device 110, a web server 148 of a merchant system 140, and/or a web server 138 of a search system 130.

An example product categorization system 120 comprises a data storage unit 123, a product tag generator 125, and a category page generator 127. In an example embodiment, the product categorization system 120 may comprise one or more computing devices comprising the data storage unit 123, the product tag generator 125, and the category page generator 127, the one or more computing devices able to communicate with the merchant system 140 and/or the search system 130 via the network 170. In certain example embodiments, the product categorization system 120 generates and/or updates category pages on a merchant website 149 based on a merchant system 140 product feed, sales data, and/or search data. In certain example embodiments, the product categorization system 120 generates and/or updates a website 149 comprising category pages hosted by a server 148 that is accessible via a shopping application 117 resident on the user computing device 110 via the network 170. In certain other example embodiments the product categorization system 120, generates and/or updates data stored on the merchant system server 148 comprising a hierarchical user interface of product category pages that may be communicated via the network 170 to a shopping application 117 on the user computing device 110 for display to the user 101.

In an example embodiment, the data storage unit 123 comprises a local or remote data storage structure accessible to the product categorization system 120 suitable for storing information. In an example embodiment, the data storage unit 123 stores encrypted information, such as HTML5 local storage.

In an example embodiment, the product tag generator 125 determines product category tags for each product listing associated with a merchant system 140 product feed. The product tag generator 125 determines product category tags based on product listing description data, product listing title data, and other product listing data, such as breadcrumb data. Example breadcrumb data represents an order for a user to navigate the website 149 to reach a product listing. For example, for a product listing titled “Pima Cotton PinTucked Open Cardigan,” a first breadcrumb reads “HomePage>Women's>Shirts>Tees & Knit Tops.” In this example, according to the breadcrumb, one way to navigate to the product listing in the current form of the merchant system 140 website 149, the user 101, starting at the “HomePage,” clicks on a “Women's” link, then a “Shirts,” link, then a “Tees & Knit Tops” link to be able to view the product listing titled “Pima Cotton PinTucked Open Cardigan.” In an example embodiment, the product tag generator 125 receives the merchant system 140 product feed data from the merchant system 140 via the network 170. In an example embodiment, the product tag generator 125 communicates the generated product category tags to the category page generator 127.

In an example embodiment, the category page generator 127 receives product category tags generated by the product tag generator 125 from the product tag generator 125. In an example embodiment, the category page generator 127 organizes the product listings associated with the merchant system 140 product feed into product category pages based on comparing product category tags of each of the product listings. For example, the category page generator 127 determines an applicability of product category tags to product listings by comparing product title and product description data against each other. In this example, the category page generator 127 generates product category pages based on the determined applicability of product category tags to product listings and integrates category pages into a website 149 hierarchy, if applicable. In an example embodiment, the category page generator 127 organizes product listings within product category pages based on one or more statistics, such as conversion rate data, average time spent data, add-to-cart rate data, trending data, bought-together data, bounce rate data, and current stock data. In an example embodiment, the category page generator 127 incorporates one or more of these data into a decision tree to organize the product listings within each particular product category page. In an example embodiment, the category page generator 127 receives conversion rate data, average time spent data, add-to-cart rate data, bought-together data, bounce rate data, and current stock data from the merchant system 140 via the network 170 as part of merchant system 140 sales statistics and/or merchant system 140 product feed data. In an example embodiment, the category page generator 127 receives search data associated with one or more keywords associated with each product listing. For example, the category page generator 127 may determine the one or more keywords associated with each product listing based on the product title data and product description data from the merchant system 140 product feed and transmit the one or more keywords associated with each product listing to the search system 130 via the network 170 along with a request for search data associated with each of the keywords. The category page generator 127 may receive, from the search system 130 via the network 170, search data comprising a search volume and/or trending indicator associated with each of the keywords. In an example embodiment, the category page generator 127 generates merchant system website 149 data that describes the website 149 incorporating all of the generated product category pages. In an example embodiment, the category page generator 127 transmits the generated website 149 data to the merchant system 140 via the network 170.

An example search system 130 comprises a search statistics generator 135, a server 138, and a website 139. An example search system 130 comprises a search engine that communicates with the product categorization system 120 via the network 170. In other example embodiments, the product categorization system 120 comprises the search system 130 or the search system 130 and the product categorization system 120 are otherwise parts of the same system. In an example embodiment, the search system 130 receives one or more keywords associated with one or more product listings along with a request for search data for each of the keywords from the product categorization system 120 via the network 170. In this example embodiment, the search system 130 may also receive one or more time periods for which to determine search statistics associated with each keyword, for example, one or more historical time periods and/or a current time period. In an example embodiment, the search system 130 determines the search statistics for each keyword and transmits the search statistics to the product categorization system 120 via the network 170.

In an example embodiment, the search statistics generator 135 comprises a component of the search system 130 that generates the search statistics associated with each keyword associated with each product listing. In an example embodiment, the search statistics generator 135 determines a search volume for each keyword during one or more predefined time periods, which may include time periods defining one or more historical time periods and/or a current time period. In another example embodiment, the search statistics generator 135 determines whether each keyword is “trending” or not and generates a trending indicator for each keyword specifying that the keyword is either “trending” or “not trending” as part of the search statistics. In an example embodiment, a trending keyword search comprises a search volume that increases above a predefined threshold rate during a certain time period. In this example embodiment, the search volume threshold required to classify a keyword as “trending” is configurable. A higher search volume threshold results in fewer product listings and keywords being identified as “trending” but the “trending” identifier will be a better indicator of popularity of product listings and have a greater marketing usefulness but may result in a lesser number of product listings being considered “trending.” In another example, a relatively lower search volume threshold will result in more product listings being placed in categories and higher percentage of those products may be inaccurately placed. In an example embodiment, the search statistics generator 135 communicates the search data comprising the one or more search volumes for each keyword and/or the trending indicator associated with each keyword to the product categorization system 120 via the network 170.

An example merchant system 140 comprises a data storage unit 143, a product feed generator 145, a sales data generator 147, a server 148, and a website 149.

In an example embodiment, the data storage unit 143 comprises a local or remote data storage structure accessible to the merchant system 140 suitable for storing information. In an example embodiment, the data storage unit 143 stores encrypted information, such as HTML5 local storage.

In an example embodiment, the product feed generator 145 comprises a component of the merchant system 140 that generates a merchant system 140 product feed. In an example embodiment, the merchant system 140 product feed comprises title data, description data, price data, and/or any other applicable data for product listings that a merchant system 140 desires to offer for sale on a merchant system 140 website 149 or application. In an example embodiment, changes to a merchant system 140 product feed are made by one or more merchant system 140 operators. For example, a marketing strategist associated with the merchant system 140 may make changes to the merchant system 140 product feed by adding product listings, deleting product listings, editing product listings, or other appropriate changes to the merchant system 140 product feed. In an example, the product feed generator 145 transmits the merchant system 140 product feed to the product categorization system 140 via the network 170 periodically or upon receiving a request from the product categorization system 120 for the merchant system 140 product feed. In another example, the product categorization system 120 has remote access to the product feed generator 145 via the network 170 and may continuously or periodically retrieve the merchant system 140 product feed data via the network 170.

In an example embodiment, the sales data generator 147 generates sales data associated with product listings associated with a merchant system 140 product feed. Example sales data comprises a conversion rate, a bounce rate, a time spent on product, an add-to-cart rate, a discount percentage, a stock indicator, a bought-together indicator, and a product newness indicator associated with one or more product listings associated with the merchant system 140 product feed. In an example embodiment, the sales data generator monitors data associated with the merchant system website 149 to determine one or more sales data. For example the sales data generator 147 may determine sales data based on transaction records, current and past virtual shopping cart statuses, current web pages of the merchant system website 149 that are being viewed and time spent on each web page, and any other interactions between users 101 and the website 149 that enable the sales data generator 147 to generate the sales data. In an example embodiment, the sales data generator 147 communicates the sales data associated with each product listing to the product categorization system 120 via the network 170. For example, the sales data generator 147 communicates the sales data to the product categorization system 120 in response to receiving a request for the sales data from the product categorization system 120 via the network 170. In another example, in response to updating one or more sales data for one or more product listings, the sales data generator 147 transmits updated sales data to the product categorization system 120 via the network 170.

In an example embodiment, the server 148 provides content accessible by the user 101 through the web browser 119 or shopping application 117 on the user computing device 110 via the network 170, including but not limited to html documents, images, style sheets, and scripts. In an example embodiment, the server 149 supports the merchant system website 149. In another example embodiment, the server 149 communicates data to and receives data from the shopping application 117 on the user computing device 110 via the network 170.

In an example embodiment, the merchant system website 149 comprises a sales website of the merchant system 140. In an example embodiment, the merchant system website 149 is accessible via the web browser 119 application of the user computing device via the network 170. In another example, the website 149 is accessible via the shopping application 117 on the user computing device 110 via the network 170 or is otherwise is accessible via the user computing device 110 over the network 170. In the example embodiments described herein, the website 149 may comprise data stored on the server 148 that is accessible via the network 170 by the shopping application 117 of the user computing device 110 and that enables a display of a hierarchical application interface comprising multiple product category pages via the shopping application 117. In an example embodiment, the merchant system website 149 displays one or more product listings associated with one or more corresponding products that the merchant system 140 offers for sale via the merchant system website 149. In an example embodiment, the merchant system website 149 comprises product category pages generated by the product categorization system 120 based on the merchant system 140 product feed and comprising organized product listings on each category page organized by the product categorization system 120 according to sales data and search data associated with each product listing. In an example embodiment, the merchant system 149 website is updated in response to changing data associated with the merchant system 140 product feed, merchant system 140 sales data, or search data. In an example embodiment, the merchant system 149 comprises a virtual shopping cart functionality that enables a user 101 to add one or more product listings to the a virtual shopping cart and initiate a checkout process. In an example embodiment, the website 149 and/or merchant system 140 processes the checkout process by communicating with an issuer system 160 associated with payment information provided by the user 101 for a transaction. In another example embodiment, the website 149 and/or merchant system 140 communicates transaction data to a payment processing system 150 associated with a digital wallet account of the user 101, wherein the payment processing system 150 processes the transaction.

An example payment processing system 150 comprises an account management component 151, a data storage unit 153, a transaction processing component 155, a server 158, and a website 159.

In an example embodiment, the account management component 151 manages one or more user 101 accounts. In an example embodiment, a user 101 account may comprise a digital wallet account, an email account, a social networking account, or any other appropriate account associated with the payment processing system 150. In an example embodiment, the account management component 151 communicates with a payment application 115 operating on a user computing device 110 associated with a user 101 having a user 101 account with the payment processing system 150. In an example embodiment, the user 101 enters payment account information into the user 101 account via the payment application 115 and the account management component 151 receives the payment account information over the network 170 and associates the received payment account information with the user 101 account.

In an example embodiment, the data storage unit 153 comprises a local or remote data storage structure accessible to the payment processing system 150 suitable for storing information. In an example embodiment, the data storage unit 153 stores encrypted information, such as HTML5 local storage.

In an example embodiment, the transaction processing component 155 receives transaction details from a merchant system 140 or merchant system website 149 and a request to initiate a transaction. Example transaction details may comprise a total amount of the transaction and a user 101 selection of a user 101 payment account associated with the user's 101 account with the payment processing system 150. For example, the user's 101 account is a digital wallet account comprising one or more payment account information corresponding to one or more respective financial payment accounts of the user 101, for example, debit accounts, bank accounts, and/or credit accounts. In an example embodiment, the transaction processing component 155 extracts payment account information from the user 101 account corresponding to the user 101 selection of the user 101 payment account received in the transaction details from the merchant system website 149. In an example embodiment, the transaction processing component 155 transmits a payment authorization request to an issuer system 160 or other appropriate financial institution associated with the payment account selected by the user 101 for use in the transaction. An example payment authorization request may comprise user 101 payment account information and a total amount of the transaction. In an example embodiment, after the issuer system 160 processes the payment authorization request, the transaction processing component 155 receives an approval or denial of the payment authorization request from the issuer system 160 over the network 170. In an example embodiment, the transaction processing component 155 transmits a receipt to the merchant system 140 and/or the user computing device 110 comprising a summary of the transaction.

In an example embodiment, the web server 158 provides the content accessible by the user 101 through the web browser 119 or payment application 115 on the user computing device 110, including but not limited to html documents, images, style sheets, and scripts. In an example embodiment, the server 158 supports the payment processing system website 159.

In an example embodiment, the payment processing system website 159 is managed by the payment processing system 150. In an example embodiment, the user 101 may access the payment processing system website 159 using the user computing device web browser 119 via the network 170. In an example embodiment, the user 101 may download the payment application onto the user computing device 110 from the website 159. In an example embodiment, the user 101 may add, delete, edit, or change payment information associated with a user's 101 digital wallet account either via the payment processing system website 159 or via the payment application 115, which communicates with the payment processing system 150 via the network 170.

An example issuer system 160 approves or denies a payment authorization request received from the payment processing system 150. In an example embodiment, the issuer system 160 communicates with the payment processing system 150 over the network 170. In another example, the issuer system 160 approves or denies a payment authorization request received from the merchant system 140 for a product purchased via the merchant system website 149 by the user 101. In this example embodiment, the issuer system 160 communicates with the merchant system 140 over the network 170. In an example embodiment, the issuer system 160 communicates with an acquirer system to approve a credit authorization and to make payment to the payment processing system 150 and/or merchant system 140. For example, the acquirer system may be a third party payment processing company.

It will be appreciated that the network connections shown are example and other means of establishing a communications link between the computers and devices can be used. Moreover, those having ordinary skill in the art having the benefit of the present disclosure will appreciate that the user computing device 110, the product categorization system 120, the search system 130, the merchant system 140, the payment processing system 150, and/or the issuer system 160 illustrated in FIG. 1 can have any of several other suitable computer system configurations. For example, a user computing device 110 embodied as a mobile phone or handheld computer may or may not include all the components described above.

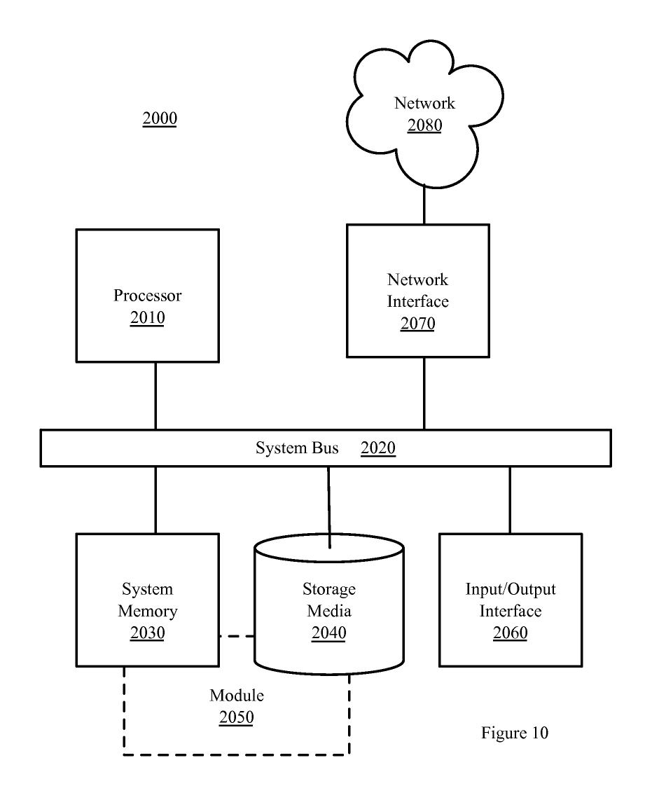

In example embodiments, the network computing devices and any other computing machines associated with the technology presented herein may be any type of computing machine such as, but not limited to, those discussed in more detail with respect to FIG. 10. Furthermore, any functions, applications, or modules associated with any of these computing machines, such as those described herein or any others (for example, scripts, web content, software, firmware, or hardware) associated with the technology presented herein may by any of the modules discussed in more detail with respect to FIG. 10. The computing machines discussed herein may communicate with one another, as well as with other computing machines or communication systems over one or more networks, such as network 105. The network 105 may include any type of data or communications network, including any of the network technology discussed with respect to FIG. 10.

### Example Processes

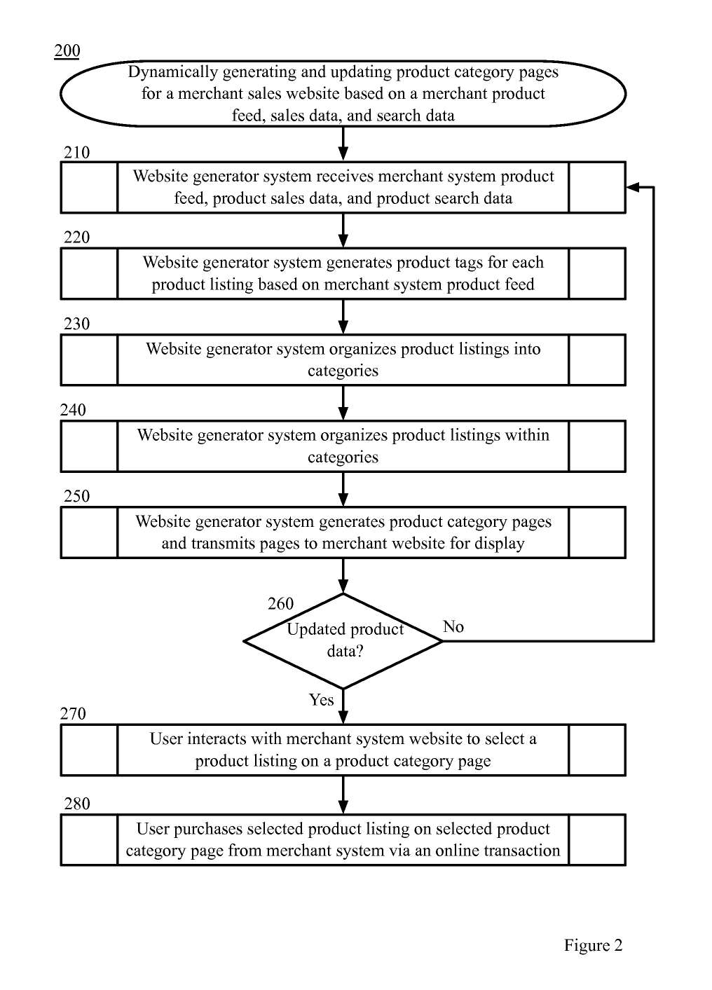

The example methods illustrated in FIGS. 2-9 are described hereinafter with respect to the components of the example operating environment 100. The example methods of FIGS. 2-9 may also be performed with other systems and in other environments.

FIG. 2 is a block diagram depicting a method 200 to dynamically generate and update product category pages for a merchant sales website based on a merchant product feed, sales data, and search data, in accordance with certain example embodiments. The method 200 is described with reference to the components illustrated in FIG. 1.

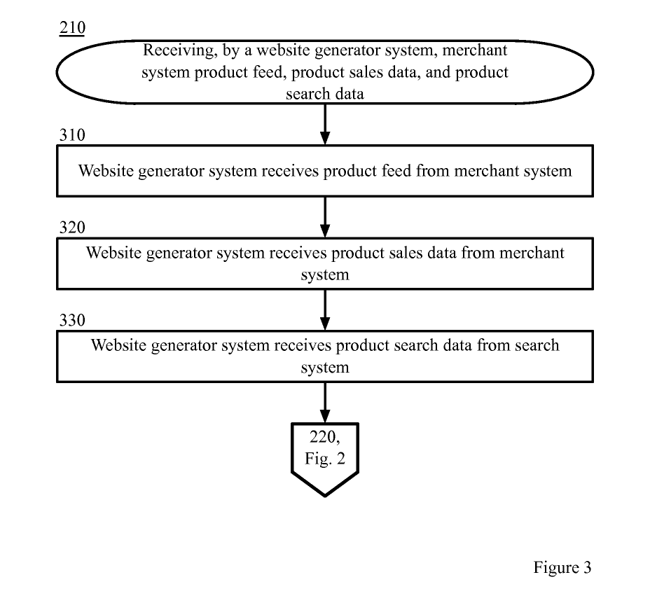

In block 210, the product categorization system 120 receives a merchant system 140 product feed, product sales data, and product search data. The method to receive, by a product categorization system 120, a merchant system 140 product feed, product sales data, and product search data, in accordance with certain example embodiments is described in more detail hereinafter with reference to the method described in FIG. 3.

FIG. 3 is a block diagram depicting a method 210 to receive, by a product categorization system 120, a merchant system 140 product feed, product sales data, and product search data, in accordance with certain example embodiments. The method 210 is described with reference to the components illustrated in FIG. 1.

In block 310, the product categorization system 120 receives a product feed from the merchant system 140. In an example embodiment, the product categorization system 120 receives the product feed from the merchant system 140 via the network 170. An example product feed comprises catalog information associated with product listings that a merchant system 140 desires to list on a merchant system website 149. The merchant system website 149 may or may not exist at the time the merchant system 140 transmits the product feed. For example, merchant system 140 transmits a product feed for the product categorization system 120 to initially generate a merchant system website 149. In another example, the merchant system website 149 already exists and the merchant system 140 transmits the product feed for the product categorization system 120 to update product category pages and/or website 149 layout of the merchant system website 149.

An example product listing describes a product for sale by the merchant system website 149. In an example embodiment, the merchant system 140 product feed comprises, for each product listing, title data of a product associated with the product listing, description data of the product associated with the product listing, and price data of the product associated with the product listing. Example title data comprises a title of the product to be displayed on the merchant system website 149 to users 101 browsing the website 149 via user computing devices 110. For example, the title data associated with a product listing in a merchant system 140 product feed reads “Pima Cotton PinTucked Open Cardigan.”

Example description data associated with the product listing comprises a text description comprising one or more words, phrases, sentences, paragraphs, alphanumeric characters and/or symbols that describe the product associated with the product listing. In an example, description data is displayed in a product listing on the merchant system website 149. In this example, the user 101 may view the description data associated with a product listing on the website 149 or may first select the title of a product listing, wherein the website 149 displays the description data to the user 101. In another example, the merchant system website 149 does not display or intend to display part or all of the description data for a product listing. For example, part or all of the description data may be for the merchant system 140 product feed only and is not marked for display on the merchant system website 149. In an example, the description data for the product listing “Pima Cotton PinTucked Open Cardigan” in the merchant system 140 product feed comprises description data that states “<bolded>Luxuriously soft </bolded>—made from the world's finest cotton. Slightly Fitted. Our most popular fit softly shapes the body; falls at low hip.” Example price data for a product listing in a merchant system 140 product feed comprises a price at which the merchant system 140 offers to sell the product associated with the product listing on the merchant system website 149. In an example, the price data comprises “$24.99” for the product listing comprising the title data “Pima Cotton PinTucked Open Cardigan.”

If the merchant system website 149 already exists, the merchant system 140 product feed may comprise, for each product listing, a uniform resource locator (“URL”) for the product listing in the merchant system website 149. In another example, the merchant system 140 product feed, for each product listing, comprises one or more breadcrumbs, that is, hierarchical website 149 location information for the product listing. For example, for a product listing titled “Pima Cotton PinTucked Open Cardigan,” a first breadcrumb reads “HomePage>Women's>Shirts>Tees & Knit Tops.” In this example, according to the breadcrumb, one way to navigate to the product listing in the current form of the merchant system 140 webpage 149, the user 101, starting at the “HomePage,” clicks on a “Women's” link, then a “Shirts,” link, then a “Tees & Knit Tops” link to be able to view the product listing titled “Pima Cotton PinTucked Open Cardigan.” The merchant system 140 product feed may comprise more than one breadcrumb for a product listing. For example, a second breadcrumb for the product listing titled “Pima Cotton PinTucked Open Cardigan” reads “HomePage>Shirts>Women's>Knit Tops.”

In block 320, the product categorization system 120 receives product sales data from the merchant system 140. In this embodiment, either the merchant system 140 website 149 already exists or the merchant system 140 comprises one or more second websites (not depicted) that offer one or more product listings associated with the merchant system 140 product feed. For example, product sales data comprises sales statistics for online sales of product listings associated with the merchant system 140 product feed. In another example, the product categorization system 120 receives the product sales data from the merchant system 140 and determines sales statistics based on the received product sales data.

In an example embodiment, product sales data for a product listing comprises a conversion rate for the product listing. An example conversion rate comprises a proportion or percentage of users 101 that, when viewing the particular product listing via a user computing device 110 on the merchant system website 149, click or otherwise select the product listing via the user interface 111 of the user computing device 110 to view more information associated with the product listing. In another example embodiment, product sales data for a product listing comprises a bounce rate associated with the product listing. For example, the bounce rate comprises a proportion or percentage of users 101 who enter a web page displaying the product listing and then leave (“bounce”) rather than continuing on to view other pages within the same site. In another example embodiment, product sales data for a product listing comprises a time spent on product. For example, the time spent on product comprises an average time spent viewing a product listing on the website 149 by users 101. In yet another example embodiment, product sales data for a product listing comprises an add-to-cart rate associated with the product listing. For example, the add-to-cart rate comprises a proportion or percentage of users 101 visiting the merchant system website 149 who add an item to a virtual shopping cart associated with the merchant system website 149.

In an example embodiment, product sales data for a product listing comprises a discount percentage associated with the product listing. For example, the discount percentage comprises a percentage discount to be applied to the product listing via the merchant system website 149 at the time of sale. In certain example embodiments, depending on the merchant system 140 sales strategy, the merchant system 140 may want to either prioritize or deprioritize product listings having discount percentages. In another example embodiment, product sales data for a product listing comprises stock indicator associated with the product listing. For example, an in-stock indicator indicates that the product associated with the product listing is available for sale via the merchant system website 149. In another example, an out-of-stock indicator indicates that the product associated with the product listing is not available for sale via the merchant system website 149. In yet another example, a limited supply indicator indicates that the product associated with the product listing is available for sale via the merchant system website 149 but in a quantity below a predefined threshold. For example, the limited supply indicator indicates that only five units of product associated with product listing A remain for sale. In an example embodiment, the threshold to determine whether a product listing is in stock instead of limited supply is configurable by the merchant system 140. For example, if a number of a product listing in stock is greater than or equal to five units, the product listing is given an “in stock” indicator by the merchant system 140. In this example, if the number of a product listing in stock is less than five units but greater than zero units, the product listing is given a “limited supply” indicator. In this example, if the number of a product listing in stock is zero units, the product listing is given an “out of stock” indicator.

In an example embodiment, product sales data for a product listing comprises a bought-together indicator. An example bought-together indicator comprises a first product listing identifier for the product listing and one or more second product listing identifiers associated with one or more second product listings that users 101 generally purchase together with the product listing via the merchant system website 149. For example, the bought-together indicator for product listing “youth tennis racket model A” comprises a product listing identifier for product listings “3-pack tennis balls brand B,” indicating that “3-pack tennis balls brand B” are often purchased together with “youth tennis racket model A” on the merchant system website 149. In another example embodiment, product sales data for a product listing comprises a product newness indicator. An example product newness indicator indicates whether the product listing is for a new product or an existing product. For example, a new product comprises a product that has been sold by the merchant system 140 for less than a threshold period of time, for example, for three months or less. An existing product, conversely, may comprise a product that has been sold by the merchant system 140 for more than the threshold period of time.

In an example embodiment, instead of receiving, from the merchant system 140, one or more statistics describing a conversion rate, a bounce rate, a time spent on product, an add-to-cart rate, a discount percentage, a stock indicator, a bought-together indicator, and a product newness indicator associated with one or more product listings in the product sales data, the product categorization system 120 determines the one or more statistics by monitoring merchant system website 149 data. For example, merchant system 140 grants the product categorization system 120 access to current and/or past merchant system website 149 data and the product categorization system 120 determines the one or more statistics from the current or past website 149 data. Merchant system website 149 data may comprise data indicating past or current virtual shopping cart status data for online shopping sessions, past or current transaction data for website 149 purchases, past or current inventory data for the website 149, past or current web pages of the website 149 being currently viewed at an associated time, and other past or current data associated with the merchant system website 149 useful to calculate or otherwise determine one or more of the statistics described previously.

In an example embodiment, merchant system website 149 data may comprise anonymous user 101 behavior data of users 101 of the website 149. For example, to determine behavior of one or more users 101 with respect to the website 149, the merchant website 149 may comprise an analytics code integrated into every web page of the website 149. Example user 101 behavior comprises time spent on a page, actions taken by the user 101, such as clicks, refreshes, selection of a back button, scrolling a web page, or other relevant user 101 interaction with one or more web pages of the website 149 may be detected via the analytics code and transmitted to one or more statistics servers of the merchant system 140. In this example, the one or more statistics servers aggregate the user 101 behavior data and may determine one or more website 149 statistics based on the user 101 behavior data. For example, the merchant system website 149 may determine a bounce rate based on data logging selection of a back button on a web page associated with a particular product listing.

In block 330, the product categorization system 120 receives product search data from the search system 130. In an example embodiment, the product categorization system 120 comprises the search system 130 or is a component of the search system 130 and already has access to product search data. In another example embodiment, the product categorization system 120 is separate from the search system 130 and transmits a request via the network 170 to the search system 130 for data associated with each product listing of a merchant system 140 product feed. The request may include all or part of the title data, description data, and/or price data associated with the product listing received from the merchant system 140 product feed. The request may further include a historical time period that enables the search system 130 to determine search volume during the historical time period for one or more keywords associated with the product listing. For example, the current marketing season is Summer and the merchant system 140 wants to determine what the search volume was for a product listing or keywords associated with the product listing during the previous Summer. In an example embodiment, the search system 130 receives the request from the product categorization system 120 via the network 170. In an example embodiment, the search system 130 determines search statistics associated with one or more keywords associated with the product listing. For example, the search system 130 determines search statistics associated with a product listing title. In another example, the search system 130 determines search statistics associated with a color, style, size, designer name, material, year, manufacturing country of origin, or other appropriate keyword derived from the description data associated with the product listing. In an example embodiment, the search system 130 determines search statistics indicating whether one or more keywords associated with a product listing are currently trending. For example, a trending search indicates that a search volume for a keyword shows an increase higher than a predefined threshold during a certain time period. The search system 130 may also determine search statistics indicating historical trending data or historical search volume for one or more keywords associated with each product listing. For example, the search system 130 determines that one or more keywords associated with a product listing were trending during the previous summer or are currently trending and assigns a trending identifier indicating “trending” or “not trending” to each of the keywords as part of the search statistics. In an example embodiment, the search system 130 transmits search statistics, for example, a trending identifier, a current search volume, and/or a historical search volume associated with one or more keywords associated with each product listing to the product categorization system 120. In an example embodiment, the product categorization system 120 receives the search statistics via the network 170 from the search system 130.

From block 330, the method 210 proceeds to block 220 of FIG. 2.

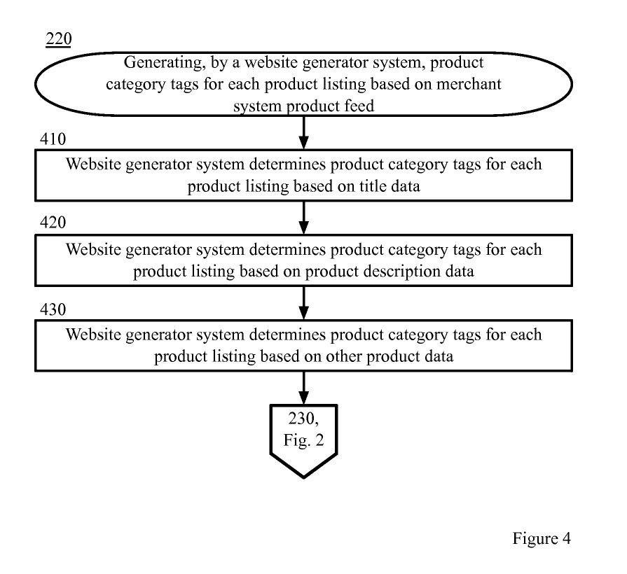

Returning to FIG. 2, in block 220, the product categorization system 120 generates product tags for each product listing based on the merchant system 140 product feed. The method to generate, by a product categorization system 120, product category tags for each product listing based on a merchant system 140 product feed is described in more detail hereinafter with reference to the method 220 described in FIG. 4.

FIG. 4 is a block diagram depicting a method 220 to generate, by a product categorization system 120, product category tags for each product listing based on a merchant system 140 product feed, in accordance with certain example embodiments. The method 220 is described with reference to the components illustrated in FIG. 1. The steps of method 220 need not be performed in the order described herein, one or more steps may be performed simultaneously, or one or more steps may be omitted.

In block 410, the product categorization system 120 determines product category tags for each product listing based on title data. For example, the product categorization system 120 determines one or more terms from the title data for a product listing to use as tags for the product listing. For example, for the product listing comprising title data “Pima Cotton Pin-Tucked Open Cardigan,” the product categorization system 120 determines tags comprising <Cotton> and <Cardigan>.

In block 420, the product categorization system 120 determines product category tags for each product listing based on product description data. For example, the product categorization system 120 determines one or more terms from the description data for a product listing to use as tags for the product listing. In an example, the product categorization system 120 extracts bolded, italicized, highlighted, or otherwise emphasized words, numbers, symbols, or phrases from the description data for the product listing to use for tags. In an example, the description data for a product listing comprises “<bolded>Luxuriously soft </bolded>—made from the world's finest cotton. Slightly Fitted. Our most popular fit softly shapes the body; falls at low hip.” In this example, the product categorization system 120 determines tags comprising <soft fabric> based on the bolded word “soft” in the description data.

In block 430, the product categorization system 120 determines product category tags for each product listing based on other product data. For example, the product categorization system 120 determines product category tags based on breadcrumb data associated with the product listing. Example breadcrumb data comprises hierarchical website 149 location information for the product listing. For example, for a product listing titled “Pima Cotton PinTucked Open Cardigan,” a breadcrumb reads “HomePage>Women's>Shirts>Tees & Knit Tops.” In this example, according to the breadcrumb, one way to navigate to the product listing in the current form of the merchant system 140 webpage 149, the user 101, starting at the “HomePage,” clicks on a “Women's” link, then a “Shirts,” link, then a “Tees & Knit Tops” link to be able to view the product listing titled “Pima Cotton PinTucked Open Cardigan.” In this example, the product categorization system 120 determines the tags <Women's shirts>, <Tees>, and <Knit Tops> based on the breadcrumb data. In certain example embodiments, the product categorization system 120 may consider a combination of title data, description data, and breadcrumb data for a product listing to determine product category tags for a product listing.

From block 430, the method 220 proceeds to block 230 in FIG. 2.

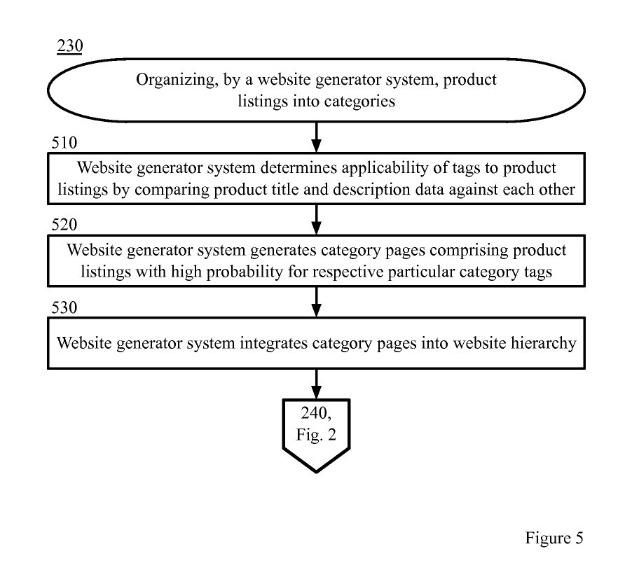

Returning to block 230, in FIG. 2, the product categorization system 120 organizes the product listings into categories. The method to organize, by a product categorization system 120, product listings into categories is described in more detail hereinafter with reference to the method 230 described in FIG. 5.

FIG. 5 is a block diagram depicting a method 230 to organize, by a product categorization system 120, product listings into categories, in accordance with certain example embodiments. The method 230 is described with reference to the components illustrated in FIG. 1.

In block 510, the product categorization system 120 determines an applicability of tags to product listings by comparing product title and description data against each other. For example, the product categorization system 120 determined applicable product category tags for each product listing associated with a merchant system 140 product feed. In an example embodiment, the product categorization system 120 scores a similarity between product listings based on title data and description data associated with each product listing. In this example embodiment, the product categorization system 120 may use a function, such as a vector based cosine similarity function to determine similarities between product listings. In another example embodiment, the product categorization system 120 uses a decision tree based algorithm that trains on existing products in the search index and produces a probability that a particular tag applies to a particular product listing.

In block 520, the product categorization system 120 generates category pages comprising product listings with a high probability for respective particular category tag. In an example embodiment, the product categorization system 120 determines whether the probability that a particular product category tag applies to a product listing passes a predefined threshold probability. In this example embodiment, if the probability is higher than the predefined threshold, the product categorization system 120 adds the product listing to the product category associated with the particular product category tag. In an example embodiment, this predefined threshold probability is configurable. A higher probability threshold results in a higher accuracy or relevance when placing products in the categories but may result in too few products being placed in a product category. On the other hand, a relatively lower probability threshold will result in more products being placed in categories but higher percentage of those products may be inaccurately placed or considered irrelevant to users.

In an example embodiment to determine a probability that particular product category tags apply to a particular product listings, the product categorization system 120 generates two groups of tuples, one group of tuples representing product listings already having assigned product category tags and another group of tuples representing product listings not having assigned product category tags. For example, to determine a probability that a particular category tag belongs to a particular product listing, the product categorization system 120 generates tuples for each product listing. For example, the product categorization system 120 generates a first set of tuples for a corresponding first set of product listings that are already associated with product category tags. For example, each tuple of the first set of tuples comprises a title, a description, and a list of tags associated with each corresponding product listing of the corresponding first set of product listings. In this example, the first set of tuples for product listings that are already associated with product category tags may be received from the merchant system 140 as part of the merchant system 140 product feed data. In another example, the first set of tuples for product listings that are already associated with product category tags may be defined by a product categorization system 120 operator. For example, the operator assigns product category tags to a first set of product listings to generate the first set of tuples. In another example, the first set of tuples for product listings that are already associated with product category tags may be determined from data associated with an existing merchant system 140 product sales website 149, for example, breadcrumb data from a previous or existing version of the website. The product categorization system 120 then may generate the first set of tuples by associating the determined product category tags for the first set of product listings with one or more merchant system 140 product feed data associated with each of the first set of product listings. In yet another example, the product categorization system 120 may generate the first set of tuples by based on data associated with a search index received from the search system 130. For example, the search index comprises a hierarchical classification of the product listings. The search listing, for each product listing, may comprise tags associated with each product listing. The product categorization system 140 may generate the first set of tuples based on the tags in the search index associated with the first set of product listings. In an example embodiment. In an example embodiment, the product categorization system 120 generates a second set of tuples for a corresponding second set of product listings that are not yet associated with product category tags. For example, each tuple of the second set of tuples comprises a title and a description but does not include a product category tag listing.

In this example embodiment, the product categorization system, for each particular tuple of the second set of tuples, determines a separate similarity score between the particular tuple and each tuple of the first set of tuples. In an example embodiment, each similarity score may be determined based on a cosine similarity between respective tuples. Specific data between each pair of tuples, such as title data or description data, may be compared to determine similarity values. The similarity scores for each specific data may then be weighted, and an overall cosine similarity score may be determined for a specific pair of tuples being compared. An overall cosine similarity score may be determined in a similar manner between each of the tuples of the second set of tuples to each of the tuples of the first set of tuples. The product categorization system 120 may normalize the overall cosine similarity scores to determine probability values for each pairing of tuples. In this example embodiment, the product categorization system 120 may assign to a particular tuple of the second set of tuples one or more product category tags from particular tuples of the first set of tuples if the probability values for the particular tuples of the first set of tuples with respect to the particular tuple of the second set of tuples are higher than a predefined threshold. In another example embodiment, the product categorization system 120 may assign to a particular tuple of the second set of tuples one or more product category tags from a predefined number of tuples of the first set of tuples having the highest probability values with respect to the particular tuple of the second set of tuples.

In block 530, the product categorization system 120 integrates category pages into a website 149 hierarchy. In an example embodiment, the product categorization system 120 determines one or more product categories that correspond to one or more existing product category pages associated with the merchant system website 149. The product categorization system 120 may determine a hierarchical organization of category pages that most closely corresponds to the existing merchant system 140 website 149. For example, the existing merchant system 140 website 149 comprises a product listing in a category page “Button up shirts,” that is within a larger product category page “Men's,” that is within an even larger category page “Clothing.” In this example, a product listing titled “Blue men's cotton button up shirt” comprises tags <Men's>, <Shirts>, <Cotton>, <Clothing>, <Blue>, and <Natural fiber> determined by the product categorization system 120 based on title data, description data, and breadcrumb data associated with the product listing in the merchant system 140 product feed. In this example, the product categorization system 120 creates a subcategory page “Natural Fibers” or “Natural Fibers, cotton” within the existing subcategory page <Clothing><Men's><Button up shirts> in the existing merchant system website 149 and adds the product listing to the generated subcategory page. In another example embodiment, the product categorization system 120 determines a logical hierarchy for one or more generated category pages that may not correspond to the existing category page hierarchy of the merchant system website 149. For example, a narrower product category page may comprise product listings and may be nested within a broader product category page comprising a larger number of product listings

From block 530, the method 230 proceeds to block 240 in FIG. 2.

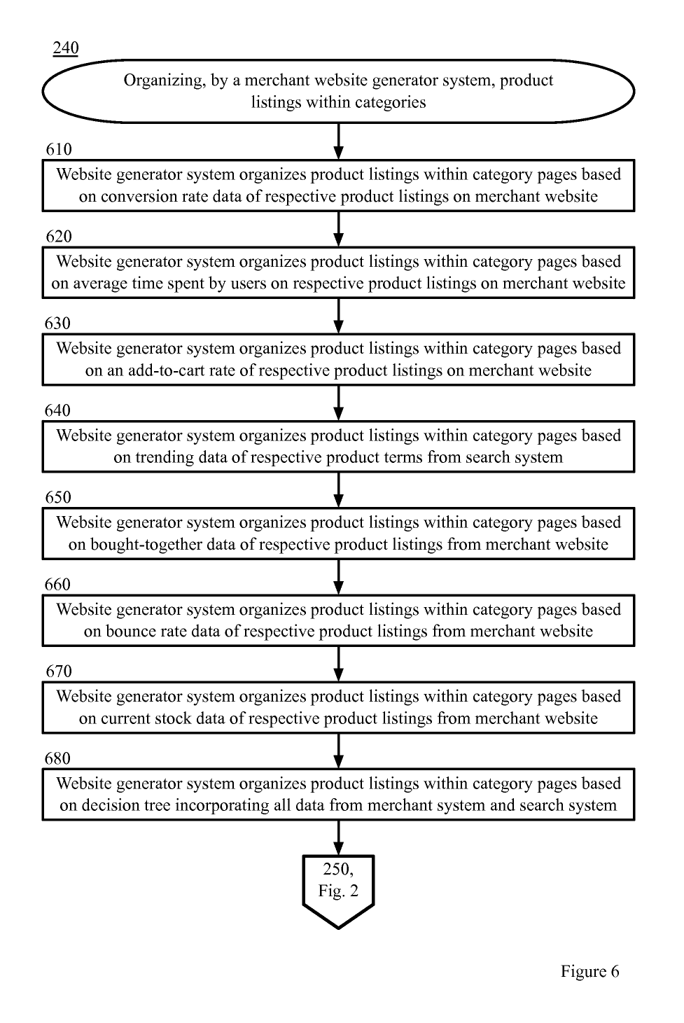

Returning to block 240, in FIG. 2, the product categorization system 120 organizes the product listings with categories. The method to organize, by a merchant product categorization system 120, product listings within categories is described in more detail hereinafter with reference to the method 240 described in FIG. 6.

FIG. 6 is a block diagram depicting a method 240 to organize, by a merchant product categorization system 120, product listings within categories, in accordance with certain example embodiments. The method 240 is described with reference to the components illustrated in FIG. 1. The steps of method 240 need not be performed in the order described herein, one or more steps may be performed simultaneously, or one or more steps may be omitted.

In an example embodiment, the product categorization system 120 places higher priority product listings at the top of category pages of a merchant system website 149. In an example embodiment, the product categorization system 120 generates category pages that display product listings to users 101 in order of priority from top to bottom of the category page and from left to right across the category page. In an example embodiment, the product categorization system 120 scores each product listing based on one or more product sales data received from the merchant system 140 and/or based on search data received from the search system 130. In this example embodiment, the product categorization system 120 gives higher priority to product listings having a higher score and lower priority to product listings having a lower score. In certain example embodiments, the merchant system 140 transmits, in addition to sales data associated with product listings, a marketing strategy or sales strategy that indicates what sales data and/or search data the merchant system 140 considers important and/or how the product categorization system 120 should interpret certain of the sales data received from the merchant system 140 and/or search data received from the search system 130. For example, the merchant system 140 marketing strategy may specify prioritizing, within product category pages, product listings having a discount percentage or prioritizing product listings not having a discount percentage. In another example, the merchant system 140 marketing strategy may specify that conversion rate is the most important consideration in organizing the product listings within product category pages. In yet another example, the merchant system 140 marketing strategy may specify weights associated with each sales statistic and/or search statistic and instructions to calculate a weighted score for each product listing and organize the product listings according to the weighted score.

In block 610, the product categorization system 120 organizes product listings within category pages based on conversion rate data of respective product listings on merchant system website 149. Example conversion rate data comprises a proportion or percentage of users 101 that, when viewing the particular product listing via a user computing device 110 on the merchant system website 149, click or otherwise select the product listing via the user interface 111 of the user computing device 110 to view more information associated with the product listing. In an example embodiment, the product categorization system 120 receives sales data comprising the conversion rate data of respective product listings associated with the merchant system 140 product feed from the merchant system 140 via the network 170. In an example embodiment, the product categorization system 120 prioritizes product listings within each generated category page having higher conversion rates. For example, the product categorization system 120, for product listings within each category page, generates a score for each product listing based on the respective conversion rate of the product and ranks or prioritizes the products based on the generated score. For example, in category page A, product listing 1 has a conversion rate of 0.05%, product listing 2 has a conversion rate of 0.07%, and product listing 3 has a conversion rate of 0.003%. In this example, the product categorization system 120 may give product listing 1 a score of 50, product listing 2 a score of 70, and product listing 3 a score of 3. In this example, within category page A and based on the generated scores for each product listing, the product categorization system 120 generates a category page that prioritizes product listing 2 over product listings 1 and 3, product listing 1 over product listing 3, and product listing 3 as the least prioritized of the product listings.

In block 620, the product categorization system 120 organizes product listings within category pages based on average time spent by users 101 on respective product listings on the merchant system website 149. An example time spent on product comprises an average time spent viewing a product listing on the website 149 by users 101. For example, the product categorization system 120, for product listings within each category page, generates a score for each product listing based on the respective time spent on product rate of the product and ranks or prioritizes the products based on the generated score. The merchant system 140 sales strategy may specify prioritizing product listings that have a higher time spent on product rate over product listings having a lower time spent on product rate and the product categorization system 120 may generate a score based on the time spent on product rate for each product listing according to the sales strategy. For example, in category page A, product listing 1 has a time spent on product rate of 35 seconds, product listing 2 has a time spent on product rate of 68 seconds, and product listing 3 has a time spent on product rate of 250 seconds. In this example, the product categorization system 120 may give product listing 1 a score of 35, product listing 2 a score of 68, and product listing 3 a score of 120. In this example, within category page A and based on the generated scores for each product listing, the product categorization system 120 generates a category page that prioritizes product listing 3 over product listings 1 and 2, product listing 2 over product listing 1, and product listing 1 as the least prioritized of the product listings.

In block 630, the product categorization system 120 organizes product listings within category pages based on an add-to-cart rate of respective product listings on merchant website. An example add-to-cart rate comprises a proportion or percentage of users 101 visiting the merchant system website 149 who add a product listing to a virtual shopping cart associated with the merchant system website 149. For example, the product categorization system 120, for product listings within each category page, generates a score for each product listing based on the respective add-to-cart rate of the product and ranks or prioritizes the products based on the generated score. The merchant system 140 sales strategy may specify prioritizing product listings that have a higher add-to-cart rate over product listings having a lower add-to-cart rate and the product categorization system 120 may generate a score based on the add-to-cart rate for each product listing according to the sales strategy. For example, in category page A, product listing 1 has an add to cart rate of 0.02, product listing 2 has an add to cart rate of 0.001, and product listing 3 has an add to cart rate of 0.035. In this example, the product categorization system 120 may give product listing 1 a score of 20, product listing 2 a score of 1, and product listing 3 a score of 35. In this example, within category page A and based on the generated scores for each product listing, the product categorization system 120 generates a category page that prioritizes product listing 3 over product listings 1 and 2, product listing 1 over product listing 2, and product listing 2 as the least prioritized of the product listings.

In block 640, the product categorization system 120 organizes product listings within category pages based on trending data of respective product terms from search system 130. For example, the product categorization system 120 requests and receives search data from the search system 130 via the network 170 for one or more keywords associated with each product listing. The search data may comprise a trending indicator for each keyword indicating whether the keyword is “trending” or “not trending” and an associated time period or time for when the trending indicator applies. For example, the trending indicator may indicate “currently trending,” “trending last Summer,” “trending last month,” or “trending Aug. 15, 2013.” The search data may comprise a search volume indicator for each keyword indicating a search volume along with an associated time or time period for when the search volume was measured. For example, search volume comprises a number of searches over a specified time period for a keyword. In an example, the product categorization system 120, for product listings within each category page, generates a score for each product listing based on the respective trending indicator and/or search volume associated with one or more keywords associated with each product listing and ranks or prioritizes the product listings based on the generated scores. The merchant system 140 sales strategy may specify prioritizing product listings that, for a particular time period, have a higher search volume and/or a “trending” indicator over product listings having a lower search volume and/or a “not trending” indicator. The product categorization system 120 may generate a score based on the trending indicator and search volume for one or more keywords associated with a product listing according to the sales strategy. In an example embodiment, the product categorization system may assign a “trending” indicator to the product listing if a majority of the keywords associated with the product listing comprise “trending” indicators and a “not trending” indicator to the product listing if only a minority of the keywords comprise “trending” indicators for a certain time period. In an example embodiment, the product categorization system 120 assigns an average search volume for a certain time period for the product listing by averaging the search volumes for each of the associated product listing keywords for that certain time period.

In an example embodiment, the product categorization system 120 may calculate a score for each product listing based on one or more of a trending indicator and a search volume, the trending indicator and the search volume being specific to a certain time period. For example, search data associated with product listing 1 in category page A comprises keyword I having a “trending” indicator, keyword II having a “not trending” indicator, and keyword “III” having a “trending” indicator for the time period of Summer, 2015. Since two of the three keywords comprise “trending” indicators in the search data, the product categorization system 120 may assign an overall “trending” indicator to the product listing. In this example, the search data associated with product listing 1 also comprises a search volume of 20000 for keyword I, 5000 for keyword II, and 5000 for keyword III. In this example, the product categorization system 120 may first determine an average search volume for the product listing based on each of the three keywords, determine a score for the product listing based on the average search volume, and modify the score based on the trending indicator for the product listing. For example, the product categorization system 120 determines a score of 20 for keyword I, 5 for keyword II, and 5 for keyword III based on the example search volumes described above and an overall search volume score of 10 for the product listing based on the average of the scores for keywords I, II, and III. In this example, the product categorization system 120 may multiply the overall search volume score for the product listing, 10, by a factor, for example, 1.5, based on the sales strategy or marketing strategy associated with the merchant system 140 to determine an overall search score of 15 for the product listing. In other examples, instead of multiplying by a factor, the product categorization system 120 may add, subtract, or use some other appropriate method to modify the overall search score based on a trending indicator. In an example, in category page A, if product listing 1 has a an overall search score of 10, product listing 2 has an overall search score of 15, and product listing 3 has an overall search score of 100. In this example, within category page A and based on the generated overall search scores for each product listing, the product categorization system 120 generates a category page that prioritizes product listing 3 over product listings 1 and 2, product listing 2 over product listing 1, and product listing 1 as the least prioritized of the product listings.

In block 650, the product categorization system 120 organizes product listings within category pages based on bought-together data of respective product listings from merchant system website 149. An example bought-together indicator comprises a first product listing identifier for the product listing and one or more second product listing identifiers associated with one or more second product listings that users 101 generally purchase together with the product listing via the merchant system website 149. For example, the bought-together indicator for product listing “youth tennis racket model A” comprises a product listing identifier for product listings “3-pack tennis balls brand B,” indicating that “3-pack tennis balls brand B” are often purchased together with “youth tennis racket model A” on the merchant system website 149.

In an example embodiment, after organizing product listings on a category page, the product categorization system 120 may prioritize a product listing by promoting it to a position next to a second product listing based on its bought-together indicator. In other example embodiments, instead of promoting a product listing, the product categorization system 120 may demote a product listing in a similar manner based on its associated bought-together identifier and the one or more product listings identified so that products that are generally bought together on the website 149 are in close proximity to one another on the product category page. In certain example embodiments, the product categorization system 120 may promote and/or demote multiple product listings within a particular category page based on the bought-together indicators of each product listing. In certain example embodiments, the product categorization system 120 may ignore bought-together indicators according to a marketing strategy received form the merchant system 140 or may not receive bought-together indicators as part of product sales data.

In an example, if the category page comprises, in order of priority, product listing 1, product listing 2, product listing 3 . . . product listing 30, and product listing 31, product listing 32, product listing 33, and product listing 34, and a bought-together indicator associated with product listing 30 indicates that it is frequently bought together with product listing 2 and product listing 32, the product categorization system 120 may promote product listing 30 and/or product listing 32 to a position in the priority ranking immediately before or immediately after product listing 2. Alternatively, the product categorization system 120, in this example, may demote product listing 2 to a position immediately before product listing 30, between product listings 30 and 32, or immediately after product listing 32. In this example, the revised priority ranking for the product category page may then comprise, in order of priority, product listing 1, product listing 2, product listing 30, product listing 2, product listing 32, product listing 3 . . . product listing 31, product listing 33, and product listing 34—or, alternatively, product listing 1, product listing 3 . . . product listing 30, product listing 2, product listing 31, product listing 32, product listing 33, and product listing 34.

In block 660, the product categorization system 120 organizes product listings within category pages based on bounce rate data of respective product listings from merchant system website 149. For example, the product categorization system 120 scores and/or prioritizes product listings based on a bounce rate for each product listing. In an example embodiment, the product categorization system 120 receives merchant system 140 sales data comprising bounce rate data associated with each product listing associated with a merchant system 140 product feed. An example bounce rate comprises a proportion or percentage of users 101 who enter a web page displaying the product listing and then leave (“bounce”) rather than continuing on to view other pages within the same website 149. For example, the product categorization system 120, for product listings within each category page, generates a score for each product listing based on the respective bounce rate of the product and ranks or prioritizes the products based on the generated score. The merchant system 140 sales strategy may specify prioritizing product listings that have a lower bounce rate over product listings having a higher bounce rate and the product categorization system 120 may generate a score based on the bounce rate for each product listing according to the sales strategy. For example, in category page A, product listing 1 has a bounce rate of 95%, product listing 2 has a bounce rate of 99%, and product listing 3 has a bounce rate of 96%. In this example, the product categorization system 120 may give product listing 1 a score of 5, product listing 2 a score of 1, and product listing 3 a score of 4. In this example, within category page A and based on the generated scores for each product listing, the product categorization system 120 generates a category page that prioritizes product listing 1 over product listings 2 and 3, product listing 3 over product listing 2, and product listing 2 as the least prioritized of the product listings.

In block 670, the product categorization system 120 organizes product listings within category pages based on current stock data of respective product listings from merchant system website 149. In an example embodiment, current stock data associated with a product listing may comprise one of an in-stock indicator, out-of-stock indicator, or a limited supply indicator. An example in-stock indicator indicates that the product associated with the product listing is available for sale via the merchant system website 149. In another example, an out-of-stock indicator indicates that the product associated with the product listing is not available for sale via the merchant system website 149. In yet another example, a limited supply indicator indicates that the product associated with the product listing is available for sale via the merchant system website 149 but in a quantity below a predefined threshold. For example, the limited supply indicator indicates that only five units of product associated with product listing A remain for sale.

In an example, the product categorization system 120, for product listings within each category page, generates a score for each product listing based on the in-stock indicator, out-of-stock indicator, or a limited supply indicator. The merchant system 140 sales strategy may specify not advertising product listings that are out of stock and preferring to offer product listings that are not in limited supply. For example, in category page A, product listing 1 has an in-stock indicator, product listing 2 has an out-of-stock indicator, and product listing 3 has a limited supply indicator. In this example, the product categorization system 120 may give product listing 1 a score of 0, product listing 2 a score of 1, and product listing 3 a score of 5. In this example, within category page A and based on the generated scores for each product listing, the product categorization system 120 generates a category page that prioritizes product listing 1 over product listings 2 and 3, product listing 3 over product listing 2, and product listing 3 as the least prioritized of the product listings.

In another example embodiment, current stock data comprises a newness indicator that indicates whether the product listing is for a new product or an existing product. For example, a new product comprises a product that has been sold by the merchant system 140 for less than a threshold period of time, for example, for three months or less. An existing product, conversely, may comprise a product that has been sold by the merchant system 140 for more than the threshold period of time. In an example, the product categorization system 120, for product listings within each category page, generates a score for each product listing based on an associated newness indicator indicating that the product listing is “new” or “not new.” The merchant system 140 sales strategy may specify not advertising product listings that are out of stock and preferring to offer product listings that are not in limited supply. For example, in category page A, product listing 1 has an “new” indicator, product listing 2 has a “not new” indicator. In this example, the product categorization system 120 may give product listing 1 a score of 15, product listing 2 a score of 1. In this example, within category page A and based on the generated scores for each product listing, the product categorization system 120 generates a category page that prioritizes product listing 1 over product listing 2.

In block 680, the product categorization system 120 organizes product listings within category pages based on a decision tree incorporating all data from the merchant system 140 and the search system 130. For example, the product categorization system 120 may first exclude product listings comprising stock indicators indicating that the product associated with the product listing is out of stock and/or in limited supply and then rank the product listings based on a conversion rate associated with each product listing. In another example, the product categorization system 120 may first rank product listings within a category page based on an add-to-cart rate associated with each product listing and then add a number of new product listings, for example, five new product listings, at the top of the category page or other highest priority position on the category page. In this example, the product categorization system 120 may then rank the five new product listings at the top of the category page based on current search volume data received from the search system 130. The product categorization system 120 may use a decision tree that includes any number of steps including ranking product listings, excluding product listings, adding product listings, promoting product listings, demoting product listings, or other appropriate actions associated with one or more product listings on a category page and based on the one or more sales statistics and/or search statistics. An example decision tree or part of an example decision tree may also prescribe an algorithm to calculate a weighted score for each product listing. For example, the decision tree may instruct the product categorization system 120 to first calculate an initial score based the conversion rate for each product listing within a product category, then multiply each of the initial scores by a multiplier value determined based on the newness factor associated with each of the product listings, where the initial score and multiplier values being determined according to a received merchant system 140 sales strategy. In this example, the decision tree may next instruct that the product categorization system 140 rank the product listings within the product category page based on the final score from highest to lowest.

In an example embodiment, the product categorization system 120 organizes product listings on one or more product category pages based on one or more objective functions. For example, the product categorization system 120 organizes product listings within a particular product category page based on an objective function that promotes older product listings (based on the newness indicator for each product listing) while not allowing an overall conversion rate of the product listings on the category page to decrease by more than ten percent from an initial overall conversion rate of a previous version of the category page. In another example, the product categorization system 120 organizes a product category page based on an objective function that selects an optimum set of product listings to display on the page in a way such that no one brand of product listing occupies more than twenty percent of available display space on the product category page. Any other appropriate objective function may be used by the product categorization system 120 to organize product listings within a product category page. In an example, an objective function may combine one or more of sales data, search data, product feed data, or other applicable data associated with one or more product listings. In this example, the objective function may be incorporated into a decision tree. In another example, a decision tree may comprise multiple objective functions to organize product listings within one or more particular product category pages.

In certain example embodiments, the product categorization system 120 may generate a weighted score for each product listing based on the importance of one or more of the one or more product sales data and/or search data associated with the product listing. For example, the product categorization system 120 may assign a weight to each of one or more sales statistics describing a conversion rate, a bounce rate, a time spent on product, an add-to-cart rate, a discount percentage, a stock indicator, a bought-together indicator, and a product newness indicator associated with each of the one or more product listings in the product sales data. The product categorization system 120 may also assign a weight to each applicable search statistic, such as a trending indicator, current search volume, or historical search volume associated with each product list. In this example, based on the sales strategy or marketing strategy of the merchant system 140, the product categorization system 120 assigns a higher weight to some sales or search statistics over other sales or search statistics. In this example, the product categorization system 120 determines, for each product listing, a sum of the scores for each applicable sales statistic and/or search statistic, each score multiplied by the corresponding weight associated with the sales statistic or search statistic on which the score is based. In this example embodiment, the product categorization system 120 orders the product listings on each generated category page according to the weighted score for each product listing. In certain example embodiments, the weighted score for each product listing may be based on one, some, or all of the available sales statistics and/or search statistics associated with the product listing.

From block 680, the method 240 proceeds to block 250, in FIG. 2.

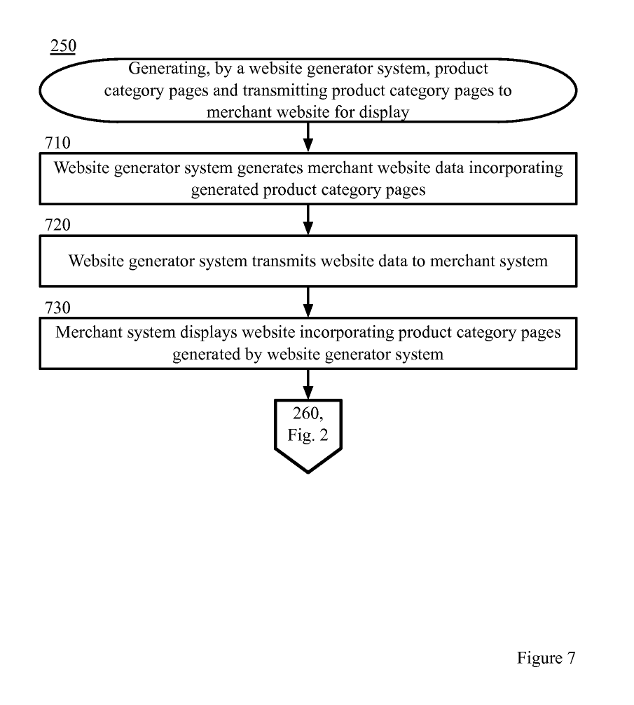

Returning to FIG. 2, in block 250, the product categorization system 120 generates product category pages and transmits the pages to the merchant system website 149 for display. The method to generate, by a product categorization system, product category pages and transmit product category pages to a merchant website for display is described in more detail hereinafter with reference to the method 260 described in FIG. 7.

FIG. 7 is a block diagram depicting a method 250 to generate, by a product categorization system, product category pages and transmit product category pages to a merchant website for display, in accordance with certain example embodiments. The method 250 is described with reference to the components illustrated in FIG. 1.

In example embodiments described herein, the product categorization system 120 generates a merchant system website 149 comprising multiple product category pages or otherwise incorporates product category pages into an existing merchant system website 149. In other example embodiments, the product categorization system 120 generates data that supports a display of product category pages within a user computing device shopping application 117 associated with the merchant system 140. In the example embodiments described herein, the functions described as being performed by the product categorization system 120 with respect to generating all or parts of the website 149 may also be embodied by the product categorization system 120 performing functions with respect to server 148 data that supports a display of a hierarchy of product category pages within a shopping application 117 interface associated with the merchant system 140.

In block 710, the product categorization system 120 generates merchant system website 149 data incorporating the generated product category pages. In an example embodiment, after ordering the product listings within each category page based on sales data and/or search data received via the network 170 from the merchant system 140 and/or the search system 130, the product categorization system 120 creates the final version of each product category page to incorporate into the merchant system website 149. In an example embodiment, the product categorization system 120 uses HTML or other appropriate language understandable to a user computing device 110 web browser 119 or shopping application 117 to describe each product category page. In an example embodiment, the product categorization system 120 generates data for the entire website 149 comprising each product category page. In another example embodiment, the product categorization system 120 generates data for each product category page of the website separately. In an example embodiment, in addition to each product category page, the product categorization system 120 generates product listing web pages, each product listing web page associated with a particular product listing. For example, an example product listing page comprises title data, description data, price data, other data from the merchant system 140 product feed, or other relevant data that a user 101 viewing the website 149 may find helpful when deciding whether to purchase the product listing on the website 149. The example product listing page may further comprise one or more user interface 111 objects that enable a user 101 to initiate one or more actions with respect to the product listing being advertised on the product listing page, for example, add the product listing to a virtual shopping cart, request further information from the merchant system 140 about the product listing, or other appropriate or relevant action. The product categorization system 120 may generate product category pages comprising links to the individual product listing pages and/or comprising links to one or more other product category pages. These links may be in the form of tabs, hyperlinks, or other appropriate format to enable a user 101 to navigate the merchant system website 149 hierarchy of web pages. Further, broader

In block 720, the product categorization system 120 transmits the website 149 data to the merchant system 140. In an example embodiment, the product categorization system 120 transmits data describing the entire website 149 comprising each product category page. In another example embodiment, the product categorization system 120 transmits separate data for each product category page of the website 149. In an example embodiment, the product categorization system 120 transmits the website 149 data to the merchant system 140 via the network 170 and the merchant system 140 receives the website 149 data via the network 170. In an example embodiment, the product categorization system 120 generates instructions to the merchant system 140 to include in the website 149 data instructing the merchant system 140 how to incorporate the new website 149 data into existing merchant system website 149 data to create an updated website 149 comprising the organized category pages as generated by the product categorization system 120.

In block 730, the merchant system 140 displays the website 149 incorporating the product category pages generated by the product categorization system 120. In an example embodiment, the merchant system 140 overwrites all or part of the underlying code of the website 149 with the website 149 data received from the product categorization system 120. In this example embodiment, the merchant system 140 may insert received website 149 data into the existing website 149 data where appropriate. In this example embodiment, the merchant system 140 may delete existing website 149 data. In an example embodiment, the received website 149 data comprises instructions to the merchant system 140 instructing the merchant system 140 how to incorporate the new website 149 data into the existing website 149 data to create an updated website 149 comprising the category pages generated by the product categorization system 120.

From block 730, the method 250 proceeds to block 260 in FIG. 2.

Returning to FIG. 2, in block 260, the product categorization system 120 determines whether updated product sales data and/or product search data are available. For example, the merchant system 140 may periodically transmit an updated merchant system 140 product feed and/or new product sales data to the product categorization system 120 via the network 170. In another example, the search system 130 may periodically transmit new search data to the product categorization system 120 via the network 170. Also, in response to receiving updated merchant system 140 product feed and/or product sales data from the merchant system 140, the product categorization system 120 may request and receive updated search data associated with the merchant system product feed via the network 170. In yet another example, the product categorization system 120 periodically requests and receives updated merchant system product feed data from the merchant system 140 and/or periodically requests and receives updated merchant system sales data from the merchant system 140 via the network 170. In yet another example embodiment, the product categorization system 120 has continuous remote access to a computing device associated with the merchant system 140 that stores the merchant system 140 product feed and/or merchant system sales data and the product categorization system 120 receives an alert signal comprising the updated sales data and/or updated product feed data via the network 170 when the merchant system product feed is updated on that computing device. A merchant system 140 may update merchant system product feed data by adding a product listing, deleting a product listing, or editing a product listing in the existing product feed data. For example, the merchant system 140 may make changes to the title data, price data, breadcrumb data, description data, or other applicable data associated with one or more product listings of the product feed data via adding, inserting, deleting, editing, or other appropriate action. A merchant system 140 may update merchant system sales data by editing one or more sales data associated with one or more existing product listings. For example, the merchant system 140 may change one or more of one a conversion rate, a bounce rate, a time spent on product, an add-to-cart rate, a discount percentage, a stock indicator, a bought-together indicator, a product newness indicator, or other appropriate statistic or indicator associated with one or more product listings in the product sales data.

If the product categorization system 120 determines that updated merchant system product feed data and/or merchant system sales data are available, the method 200 returns to block 210. In an example embodiment, the product categorization system 120 receives an merchant system updated product feed, updated product sales data, and/or updated product search data from the merchant system 140 and/or the search system 130. As previously discussed, the product categorization system 120 may generate product tags for each product listing based on the merchant system product feed data. For example, the tags may be generated based on the title data, description data, breadcrumb data, and/or price data associated with each product listing in the merchant system 140 product feed as discussed previously herein. In an example embodiment, the product categorization system 120 assigns product listings to product categories based on the tags associated with each product listing and organizes the product listings within the product categories based on sales data and search data to create product category pages for the merchant system website 149. The product categorization system 120 may then generate an updated website 149 comprising one or more updated product category pages. The updated website 149 may include additional product category pages not present in the previous version of the website 149, may include changes to existing product category pages that were present in the previous version of the website 149, or may delete product category pages that previously existed in the previous version of the website 149. For example, the product categorization system 120, in editing an existing product category page, may rearrange the order of the product listings on the pages in response to changes in merchant system sales data and/or changes in the sales data. In this example, the product categorization system 120 may also add or delete items from existing product category pages based on additions, deletions, or edits that the merchant system 140 made to an updated merchant system 140 product feed. In an example embodiment, the product categorization system 120 generates a code or other data representing the updated website 149 or updated sections of the existing website 149 and transmits the updated website 149 data to the merchant system 140 via the network 170 along with instructions instructing the merchant system 140 how to incorporate the updated website 149 data into the existing website 149. In an example embodiment, the merchant system 140 overwrites the previous version of the website 149 with the received website 149 data. In another example, the merchant system 140 may insert or overwrites updated website 149 data into the existing website 149 and delete, cut and paste, or otherwise some or all of the previous website 149 data to integrate updated portions of the website 149 generated by the product categorization system 120 into the existing website 149 data representing the previous version of the website 149. In an example embodiment, the merchant system 140 displays the updated website 149 comprising any updates, additions, deletions, rearrangements, or other appropriate actions taken by the product categorization system 120 in response to the new product feed data, sales data, and/or search data with respect to the previous version of the website 149.

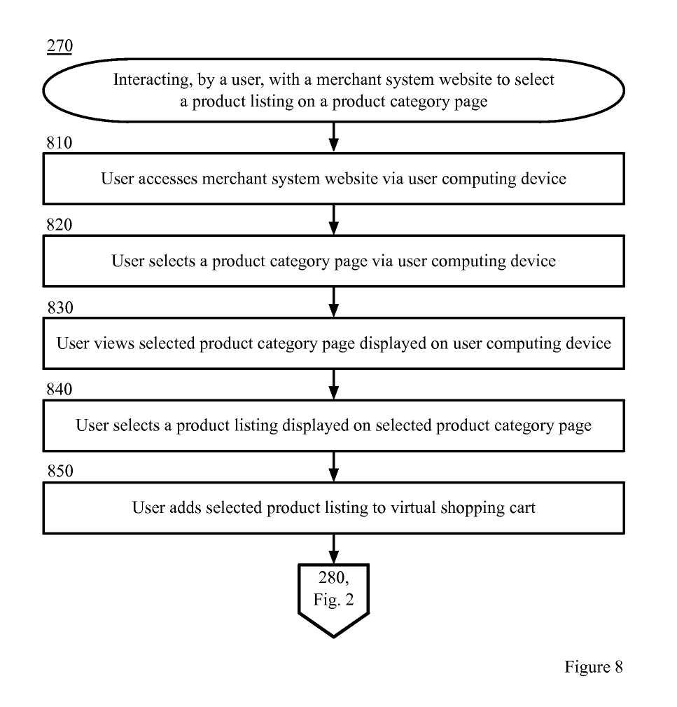

Returning to block 260, if the product categorization system 120 determines that updated merchant system product feed data and/or merchant system sales data are not available, the method proceeds to block 270. In block 270, the user 101 interacts with merchant system website 149 to select a product listing on a product category page. The method to interact, by a user, with a merchant system website to select a product listing on a product category page is described in more detail hereinafter with reference to the method 270 described in FIG. 8.

FIG. 8 is a block diagram depicting a method 270 to interact, by a user, with a merchant system website to select a product listing on a product category page, in accordance with certain example embodiments. The method 270 is described with reference to the components illustrated in FIG. 1.

In block 810, the user 101 accesses the merchant system website 149 via the user computing device 110. In an example embodiment, the user computing device 110 comprises a web browser 119 application and the user accesses the merchant system website 149 using the web browser 119 via the network 170. For example, the user 101 enters the website 149 address into an address bar of the web browser 119 via the user interface 111. In another example, the user 101 is on another website and selects via the user interface 111 a link that redirects the web browser 119 to the merchant system website 149 via the network 170. In another example embodiment, the user 101 accesses the merchant system website 149 via the user computing device 110 using a shopping application 117. An example shopping application 117 is associated with the merchant system 140 and communicates with the merchant system server 148 via the network 170 to display the merchant system website 149 on the user computing device 110. In this example embodiment, to access the merchant system website 149, the user 101 may select the shopping application 117 icon via the user interface 111 to open the shopping application 117, which accesses the merchant system website 149 via the network 170.

In block 820, the user 101 selects a product category page via the user computing device 110. As described in certain example embodiments herein, the merchant system 140 website 149, as generated by the product categorization system 120, comprises multiple product category pages, each product category page comprising one or more product listings derived from a merchant system product feed. The website 149 may comprise a hierarchy of product category pages within other product category pages. For example, the user 101 may first access a home page associated with the merchant system website 149 and select a product category page “Clothing.” In this example, the user 101 may be presented with a display of the “Clothing” category page comprising one or more product listings associated with a product tag “clothing.” The website 149 may also display one or more suggested links to subcategories “Men's clothing,” “Women's clothing,” “Girl's clothing,” “Boys clothing,” “Baby Clothing,” “Winter clothing,” and “Summer clothing.” In this example the user 101 may select the subcategory link “Men's clothing,” and the web browser 119 is directed to the “Men's clothing” category page comprising one or more product listings associated with product tags “Men's” and “Clothing.” This category page may further comprise one or more suggested links to subcategories “Men's summer clothing,” “Men's winter clothing,” “Men's formal clothing.” In this example, the user 101 may select the subcategory link “Men's formal clothing,” and the web browser 119 is directed to the “Men's formal clothing” category page comprising one or more product listings associated with the product tags “Men's,” “clothing,” and “formal clothing.” In an example embodiment, the user 101 may continue to navigate the website 149 by clicking on category and subcategory links to browse category pages of varying specificity.

In block 830, the user 101 views the selected product category page displayed on the user computing device 110. In an example embodiment, the user computing device 110 displays the selected product category page via the web browser 119 or shopping application 117. For example, the user 101 may arrive at a product category page titled “Men's natural fiber winter clothing” comprising product listings titled, among others, “herringbone pattern wool Men's blue checkered scarf,” “long sleeve Men's t-shirt, cotton, solid colors” and “100% wool Men's Sanquhar gloves, Prince of Wales pattern.” In an example embodiment, the product category page comprises product listings that are organized in a list, a block pattern, or other appropriate arrangement. In an example embodiment, each product listing comprises one or more links that enable the user 101 to view more information about the product listing, view the product description and/or the price of the product associated with the product listing, and add the product listing to a virtual shopping cart associated with the merchant system website 149.

In block 840, the user 101 selects a product listing displayed on the selected product category page. For example, the user 101 selects the product listing “100% wool Men's Sanquhar gloves, Prince of Wales pattern.” In this example, the user 101 may further select, enter, or otherwise input one or more product listing parameters comprising a quantity, color, size, and/or other specific product configuration via one or more drop down menus, text entry areas, checkboxes, and/or other appropriate user interface 111 objects. For example, the user 101 selects a “medium” size for the gloves and “black and white” for the color of the gloves. In an example embodiment, the user may input one or more product listing parameters for a particular product listing directly on a product category page that comprises the product listing. In another example embodiment, the user 101 may select the product listing (for example, select a link associated with the product listing) on the product category page, which causes the web browser 119 or shopping application 117 of the user computing device 110 to be redirected to a web page devoted to the individual product listing selected by the user 101. In this example embodiment, the user may input one or more product listing parameters on the product listing page associated with the individual, selected product listing.

In block 850, the user 101 adds the selected product listing to a virtual shopping cart. In an example embodiment, the product listing displays a user interface 111 object, either on the product category page comprising the selected product listing or on an individual product listing page associated with the selected product listing, that the user 101 may select via the web browser 119 on the user computing device 110 that instructs the merchant system website 149 to add the selected product listing to the virtual shopping cart associated with the website 149. In an example embodiment, the user 101 adds multiple product listings displayed on the merchant system website 149 from one or more category pages and/or individual product listing pages to the virtual shopping cart. In an example embodiment, the user 101 may delete one or more product listings or edit one or more product parameters, such as quantify, color, size, or other specific parameters via user interface 111 objects displayed on the virtual shopping cart.

From block 850, the method 270 proceeds to block 280 in FIG. 2.

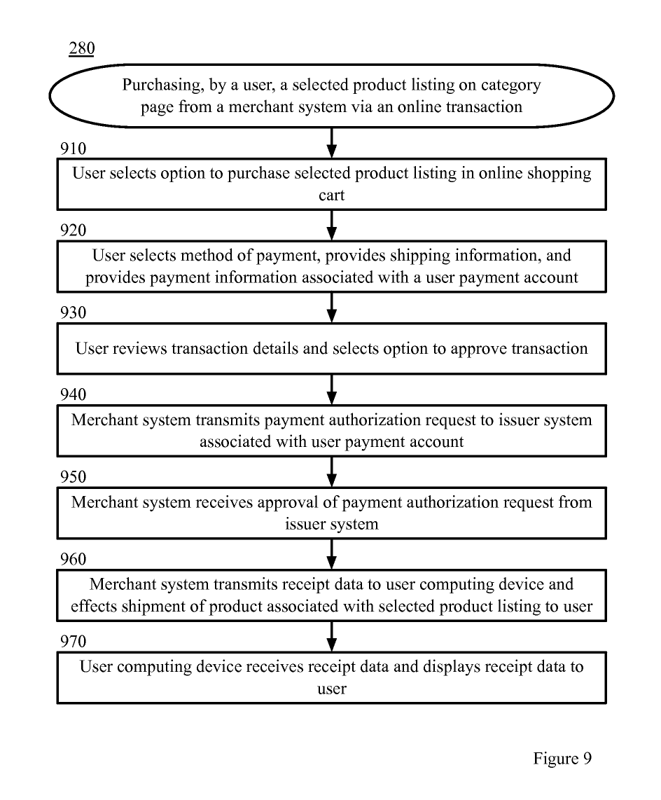

Returning to FIG. 2, in block 280, the user 101 purchases the selected product listing on the selected product category page from the merchant system 140 via an online transaction. The method to purchase, by a user, a selected product listing on a category page from a merchant system via an online transaction is described in more detail hereinafter with reference to the method 280 described in FIG. 9.

FIG. 9 is a block diagram depicting a method 280 to purchase, by a user, a selected product listing on a category page from a merchant system via an online transaction, in accordance with certain example embodiments. The method 280 is described with reference to the components illustrated in FIG. 1.

In block 910, the user 101 selects an option to purchase the selected product listing in the online shopping cart. For example, the user 101 selects a user interface 111 object that reads “checkout,” to initiate a checkout process. In an example, in response to receiving the user 101 selection of the checkout interface object, the merchant system website 149 provides a summary of the product listings that are in the virtual shopping cart and provides transaction data comprising a subtotal price, a tax amount, and a total price including tax, and other applicable information.

In block 920, the user 101 selects a method of payment, provides shipping information, and provides payment information associated with a user 101 payment account. In an example embodiment, the website 149 displays one or more payment options to a user 101 comprising payment via credit card, debit card, bank account, digital wallet account, merchant system account, and/or other applicable payment options offered by the merchant system 140 website 149. For example, a user 101 may select an option to make a payment via credit card. In an example embodiment, in response to the user 101 selecting a method of payment, the merchant system website 149 requests payment information, such as an account number, security code associated with a payment instrument, a name associated with an account, a billing address, an expiration date associated with a payment instrument, and/or other applicable financial account data. In this example embodiment, the user 101 enters the requested payment information on the website 149 via the user interface 111. In an example embodiment, the merchant system website 149 displays one or more shipment methods and requests the user 101 to select a particular shipment method. In an example embodiment, the user 101 selects one or more user interface 111 objects to indicate a selection of a particular shipment method to the merchant system website 149.

In block 930, the user 101 reviews transaction details and selects an option to approve the transaction. In an example embodiment, the merchant system website 149 displays a summary of the products being purchased, a total price including any applicable taxes, the payment information entered by the user 101, the selected shipment method selected by the user 101, an expected delivery date, and other applicable transaction details. In an example embodiment, the merchant system website 149 requests that the user 101 either confirm or cancel the transaction after reviewing the transaction details. For example, the merchant system website 149 displays a first user interface 111 object reading “I confirm this transaction” and a second user interface 111 object that reads “Cancel transaction.” In an example embodiment, the user 101 selects the option to confirm the transaction and the merchant system website 149 receives an indication of the user 101 selection of the option to confirm the transaction.

In block 940, the merchant system 140 transmits a payment authorization request to an issuer system 160 associated with the user payment account. For example, the payment authorization request may comprise a total amount of the transaction, account information associated with the merchant system 140, and the user 101 financial account information provided by the user 101 for use in the transaction. In this example, the issuer system 160 receives the transaction authorization request and approves or denies the transaction. For example, the issuer system 160 may approve or deny the transaction authorization request based on a credit limit of the user, the current credit balance of the user's 101 financial account, the total amount of the current transaction, and/or other relevant information to which the issuer system 160 has access. The issuer system 160 may approve the transaction and generate an approval notice to transmit to the merchant system 140. In this example, in processing the transaction, the issuer system 160 may add a charge, withdraw funds, or otherwise debit the user's 101 financial account associated with the issuer system 160 and add a credit, add funds, or otherwise credit an account of the merchant system 140. In another example, the issuer system 160 may deny the payment authorization request received from the merchant system 140. In this example, the issuer system 160 may generate a notice of denial of the payment authorization request to transmit to the merchant system 140.

In block 950, the merchant system 140 receives an approval of the payment authorization request from the issuer system 160. In an example embodiment, in response to receiving the approval of the payment authorization request, the merchant system 140 effects shipment of the user's 101 purchased one or more products and generates receipt data comprising a notice of a successful transaction to transmit to the user computing device 110 or otherwise transmit to the user 101. In another example embodiment, the merchant system 140 receives a notice of declined payment authorization request from the issuer system 160 and generates receipt data comprising a transaction cancellation notice to transmit to the user computing device 110 or otherwise transmit to the user 101.

In block 960, the merchant system 140 transmits receipt data to the user computing device 110 and effects shipment of the product associated with the selected product listing to the user 101. In an example embodiment, the receipt data comprises a notice of successful transaction, an expected shipment date, a summary of the products purchased in the transaction and a total amount charged, an indication of the user 101 financial account charged, and other useful information to summarize the successful transaction. In another example, the receipt data comprises a notice of declined transaction.

In certain other example embodiments, instead of the merchant system 140 processing a transaction for a product purchased by the user 101 from the merchant system 140 website 149, a payment processing system 150 associated with a digital wallet account of the user 101 processes a payment transaction using financial account information selected by the user 101 via a payment application 115 resident on the user computing device 110. In an example embodiment, the user 101 establishes a digital wallet account with the payment processing system 150 by accessing a website 159 of the payment processing system 150 using the user computing device 110 and registering for a digital wallet account via the website 159. In an example embodiment, the user 101 downloads a payment application 115, such as a digital wallet application, associated with the payment processing system 150 from the payment processing system website 159 onto the user computing device 110. In an example embodiment, the user 101 enters financial account information associated with one or more financial accounts of the user 101 into the digital wallet account maintained by the payment processing system 150 via the payment application 115. For example, the payment application 115 is able to send and receive data to and from the payment processing system 150 via the network 170.

In an example embodiment, one of the payment options offered by the merchant system website 149 is an option to pay using the payment application 115. For example, the payment options displayed may be “credit card type A, credit card type B, bank account, digital wallet payment application 115, merchant system 140 account.” In this example, the user 101 selects the payment option comprising “digital wallet payment application 115,” and in response to the user 101 selection, the payment application 115 opens on the user computing device 110. In this example, the payment application 115 communicates with the payment processing system 150 to retrieve and display to the user 101 financial account information associated with one or more user 101 accounts that the user 101 has uploaded to the user's 101 digital wallet account. In this example, the user 101 selects a particular financial account via the payment application 115 and the payment application 115 communicates an indication of the user 101 selection to the payment processing system 150. In this example, the payment processing system 150 generates a payment authorization request and communicates the authorization request to an issuer system 160 associated with the user 101 selected financial account information. In an example, the payment processing system 150 receives a notice of approval of the payment authorization request and communicates the notice of approval to the merchant system website 149 and/or the user computing device 110 to display confirmation of a successful transaction to the user 101.

In block 970, the user computing device 110 receives receipt data and displays the receipt data to the user 101. In an example, the receipt data comprises a notice of successful transaction, an expected shipment date, a summary of the products purchased in the transaction and a total amount charged, an indication of the user 101 financial account charged, and other useful information to summarize the successful transaction. In another example, the receipt data comprises a notice of declined transaction. In an example embodiment, the user 101 receives the receipt data via the shopping application 117, via an email application, via the payment application 115, or via some other appropriate method to receive the receipt data on the user computing device 110 via the network 170. In an example embodiment, the receipt data showing an approved or declined transaction is displayed to the user 101 on the user interface 111 of the user computing device 110.

### Other Example Embodiments

FIG. 10 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, such as module 2050, data, or any other information. The storage media 2040 may be part of, or connected to, the computing machine 2000. The storage media 2040 may also be part of one or more other computing machines that are in communication with the computing machine 2000, such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device, such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to automatically generate and present product category pages comprising related product listings, comprising:
receiving, by one or more computing devices, product feed data and product sales data from a merchant system, the product feed data comprising a plurality of product listings to offer for sale via a merchant system application, each product listing comprising a corresponding product title and product description, and the product sales data comprising sales data related to each of the product listings;
assigning, by the one or more computing devices, one or more product category tags to each product listing in a first set of the product listings based at least in part on the product title and product description of each product listing in the product feed data;
identifying, by the one or more computing devices, a second set of the product listings that do not have the one or more assigned product category tags;
comparing, by the one or more computing devices, the product feed data for each of the second set of the product listings with the product feed data for each of the first set of the product listings to determine a separate similarity value between each of the second set of the product listings with respect to each of the first set of the product listings;
assigning, by the one or more computing devices and for each of the second set of the product listings, one or more of the category tags associated with a particular one of the first set of the product listings based on a threshold similarity value between the particular one of the first set of the product listings with respect to the particular one of the second set of the product listings;
grouping, by the one or more computing devices and for each assigned product category tag, all product listings associated with the assigned product category tag into a product category group to create a plurality of product category groups;
organizing, by the one or more computing devices, one or more product listings within each product category group based on the product sales data corresponding to the product listings each product category group;
generating, by the one or more computing devices, page data comprising instructions to create individual product category user interface pages that each correspond to a respective one of the product category groups and that each include the organized product listings corresponding to the respective one of the product category groups; and
transmitting, by the one or more computing devices, the page data instructions to the merchant system to instruct presentation of the individual product category user interface pages via the merchant system application.

2. The method of claim 1, wherein the page data instructions instruct presentation of the individual product category user interface pages via a merchant system sales website.

3. The method of claim 1, wherein the page data instructions instruct presentation of the individual product category user interface pages via a display for a user computing device application associated with the merchant system.

4. The method of claim 1, further comprising
generating, by the one or more computing devices and for a first set of product listings having predefined product category tags, a corresponding first set of tuples comprising title data, description data, and existing product category tags associated with each of the first set of product listings,
wherein determining the separate similarity value between each of the second set of the product listings with respect to each of the first set of the product listings comprises determining a similarity between each of the second set of tuples with respect to each of the first set of tuples.

5. The method of claim 1, wherein determining the separate similarity value between each of the second set of the product listings with respect to each of the first set of the product listings comprises:
determining, by the one or more computing devices, a first cosine similarity value between the title data of each of the second set of the product listings and the title data of each of the first set of the product listings;
determining, by the one or more computing devices, a second cosine similarity value between the description data of each of the second set of the product listings and the description data of each of the first set of the product listings; and
determining, by the one or more computing devices, the separate similarity value based on the first and second cosine similarity values.

6. The method of claim 5, wherein determining the separate similarity value based on the first and second cosine similarity values comprises computing a weighted average of the first and second cosine similarity values, and wherein the weight associated with the second cosine similarity value is different from the weight associated with the first cosine similarity value.

7. The method of claim 1, wherein the product feed data further comprises a price and breadcrumb data associated with each product listing.

8. The method of claim 1, further comprising receiving, by the one or more computing devices and from a search system, search data associated with one or more keywords associated with each product listing for one or more historical or current time periods, wherein the one or more product listings within each product category page is further organized based on the received search data.

9. The method of claim 8, wherein the search data comprise a search volume for each keyword of the one or more keywords associated with each product listing for the one or more historical or current time periods.

10. The method of claim 8, wherein the search data comprises a trending indicator for each keyword of the one or more keywords associated with each product listing for the one or more historical or current time periods, wherein an affirmative trending indicator indicates that the search volume increased at a rate above a threshold rate during one or more of the applicable time periods, and wherein a not-trending indicator indicates that the search volume did not increase at a rate above a threshold rate during one or more of the applicable time periods.

11. The method of claim 8, further comprising:
determining, by the one or more computing devices and in response to receiving the product feed data, one or more keywords associated with each product listing based on the product feed data; and
transmitting, by the one or more computing devices and to the search system, a request for search data associated with each of the one or more keywords and the one or more historical or current time periods.

12. The method of claim 1, further comprising:
receiving, by the one or more computing devices and from the merchant system, updated product sales data;
reorganizing, by the one or more computing devices, one or more product listings within one or more existing product category groups based on the updated product sales data to produce one or more updated product category pages;
generating, by the one or more computing devices, updated page data comprising instructions to create updated individual product category user interface pages that each correspond to a respective one of the product category groups and that each include the reorganized product listings corresponding to the respective one of the product category groups; and
transmitting, by the one or more computing devices, the updated page data instructions to the merchant system to instruct presentation of the updated individual product category user interface pages via the merchant system application.

13. The method of claim 1, further comprising:
receiving, by the one or more computing devices and from the merchant system, updated product feed data different from the product feed data;
assigning, by the one or more computing devices, one or more product category tags to each product listing in the updated product feed data based on the updated product feed data;
grouping, by the one or more computing devices and for each assigned product category tag, all product listings associated with the assigned product category tag into a product category group to create a set of second product category groups based on the updated product feed data;
generating, by the one or more computing devices, updated page data comprising instructions to create individual product category user interface pages, each corresponding to a respective one of the second product category groups and including the organized product listings corresponding to the respective one of the second product category groups; and
transmitting, by the one or more computing devices, the updated page data instructions to the merchant system to instruct presentation of the individual product category user interface pages via the merchant system application.

14. The method of claim 1, further comprising:
receiving, by the one or more computing devices and from the merchant system, updated product feed data and updated sales data different from the product feed data and the product sales data;
assigning, by the one or more computing devices, one or more product category tags to associate with each product listing in the updated product feed based on the updated product feed data;
grouping, by the one or more computing devices and for each assigned product category tag, all product listings associated with the assigned product category tag into a product category group to create a set of second product category groups based on the updated product feed data;
organizing, by the one or more computing devices, one or more product listings within each generated second product category group based on the updated product sales data;
generating, by the one or more computing devices, updated page data comprising instructions to create individual product category user interface pages, each corresponding to a respective one of the second product category groups and including the organized product listings corresponding to the respective one of the second product category groups; and
transmitting, by the one or more computing devices, the updated page data instructions to the merchant system to instruct presentation of the individual product category user interface pages via the merchant system application.

15. The method of claim 1, wherein the sales data comprises one or more of a conversion rate, a bounce rate, an average time spent on product listing, or an add-to-cart rate associated with each product listing of the product feed.

16. The method of claim 1, wherein the sales data comprises bought-together data for each product listing of the product feed indicating both an identification of a first product listing and one or more identifications of second product listings that are determined by a merchant system to be bought together often with the identified first product listing.

17. The method of claim 1, wherein the sales data comprises a current stock indicator associated with each product listing indicating whether each product listing is in stock, not in stock, or in stock but in limited supply.

18. The method of claim 1, wherein the one or more product listings are organized within each generated product category group by analyzing product sales as part of a decision tree.

19. The method of claim 1, wherein the generated page data integrates the one or more generated, organized product category pages into a previously existing hierarchal web page structure of the merchant system website.

20. A computer-readable program product, comprising:
a non-transitory computer-readable medium having computer-executable program instructions embodied thereon that when executed by a computer cause the computer to dynamically generate websites comprising product category pages based on product data and sales data provided by merchant systems by:
receiving, by one or more computing devices, product feed data and product sales data from a merchant system, the product feed data comprising a plurality of product listings to offer for sale via a merchant system website, and the product sales data comprising sales data related to each of the product listings;
identifying, by the one or more computing devices, one or more product category tags assigned to each product listing in a first set of the product listings;
identifying, by the one or more computing devices, a second set of the product listings that do not have the one or more assigned product category tags;
comparing, by the one or more computing devices, the product feed data for each of the second set of the product listings with the product feed data for each of the first set of the product listings to determine a separate similarity value between each of the second set of the product listings with respect to each of the first set of the product listings;
assigning, by the one or more computing devices and for each of the second set of the product listings, one or more of the category tags associated with a particular one of the first set of the product listings based on a threshold similarity value between the particular one of the first set of the product listings with respect to the particular one of the second set of the product listings;
grouping, by the one or more computing devices and for each assigned product category tag, all product listings associated with the assigned product category tag into a product category group to create a plurality of product category groups;
organizing, by the one or more computing devices, one or more product listings within each product category group based on the product sales data corresponding to the product listings each product category group;
generating, by the one or more computing devices, page data comprising instructions to create individual product category user interface pages that each correspond to a respective one of the product category groups and that each include the organized product listings corresponding to the respective one of the product category groups; and
transmitting, by the one or more computing devices, the page data instructions to the merchant system to instruct presentation of the individual product category user interface pages via the merchant system website.

21. A system to dynamically generate and present websites comprising product category pages based on product data and sales data provide by merchant systems, comprising:
a storage device; and
a processor communicatively coupled to the storage device, wherein the processor executes application code instructions that are stored in the storage device to cause the system to:
receive, by one or more computing devices, product feed data and product sales data from a merchant system, the product feed data comprising a plurality of product listings to offer for sale via a merchant system website, each product listing comprising a corresponding product title and product description, and the product sales data comprising sales data related to each of the product listings;
assign, by the one or more computing devices, one or more product category tags to each product listing in a first set of the product listings based at least in part on the product title and product description of each product listing in the product feed data;
identify, by the one or more computing devices, a second set of the product listings that do not have the one or more assigned product category tags;
compare, by the one or more computing devices, the product feed data for each of the second set of the product listings with the product feed data for each of the first set of the product listings to determine a separate similarity value between each of the second set of the product listings with respect to each of the first set of the product listings;
assign, by the one or more computing devices and for each of the second set of the product listings, one or more of the category tags associated with a particular one of the first set of the product listings based on a threshold similarity value between the particular one of the first set of the product listings with respect to the particular one of the second set of the product listings;
group, by the one or more computing devices and for each assigned product category tag, all product listings associated with the assigned product category tag into a product category group to create a plurality of product category groups;
organize, by the one or more computing devices, one or more product listings within each product category group based on the product sales data corresponding to the product listings each product category group;
generate, by the one or more computing devices, page data comprising instructions to create individual product category user interface pages that each correspond to a respective one of the product category groups and that each include the organized product listings corresponding to the respective one of the product category groups; and
transmit, by the one or more computing devices, the page data instructions to the merchant system to instruct presentation of the individual product category user interface pages via the merchant system website.
